(19) United States
(12) Patent Application Publication
(10) Pub. No.: US 2012/0189833 A1
(43) Pub. Date: Jul. 26, 2012

(54) ALPHA ALUMINA (CORUNDUM) WHISKERS AND FIBROUS-POROUS CERAMICS AND METHOD OF PREPARING THEREOF

(75) Inventors: Wojciech L. Suchanek, Solon, OH (US); Juan M. Garces, Midland, MI (US)

(73) Assignee: Sawyer Technical Materials LLC, Eastlake, OH (US)

(21) Appl. No.: 12/369,154

(22) Filed: Feb. 11, 2009

Related U.S. Application Data
(60) Provisional application No. 61/027,612, filed on Feb. 11, 2008.
(60) Provisional application No. 61/029,706, filed on Feb. 19, 2008.
(60) Provisional application No. 61/030,638, filed on Feb. 22, 2008.
(60) Provisional application No. 61/104,146, filed on Oct. 9, 2008.

(51) Int. Cl. C01F 7/30; D02G 3/22; B01J 21/04; C01F 7/02; C04B 35/622; C04B 35/10

(52) U.S. Cl. 428/219; 423/625; 501/153; 423/626; 501/134; 502/439; 428/401; 428/400

(57) ABSTRACT

Materials and associated processes for making the materials. For example the material may include alpha alumina crystalline whiskers. The process may include conducting the process as hydrothermal, and producing the whiskers to have a length to diameter aspect ratio of at least two.

### BACKGROUND

### Alpha Alumina (Corundum) Whiskers/Fibers and Porous Ceramics—Properties and Applications

Alpha alumina (α-Al₂O₃, corundum, denoted hereafter as AA) is one of the most widely used ceramics due to a combination of such useful properties as high mechanical strength and hardness, good wear resistance, low electric conductivity, high refractoriness, and high corrosion resistance in a broad range of chemical environments. Applications of AA include abrasive materials, electric insulators (spark plugs, electronic circuits substrates, packaging, etc.), structural ceramics (wear resistant parts, bearings, nozzles, seats, cutting tools, medical/dental implants, grinding media, ceramic armor, etc.), vacuum tube envelopes, refractory bricks, liners, and sleeves used in metallurgical applications, kiln furnaces, etc., laboratory ware, catalytic supports, etc.

Mechanical properties of the AA ceramics are of a particular interest in view of almost any application. They can be improved further by the use of fibrous reinforcements, such as whiskers or long fibers. Fibrous AA in form of whiskers or long fibers (polycrystalline or single crystal) is commercially available and is being used to reinforce porous or dense ceramics, such as alumina and others. The fibrous reinforcement is particularly important and efficient in porous AA ceramics. A large fraction of the alumina ceramics production is being used in a porous form as corrosion-resistant thermal insulations in a variety of refractory applications, membranes, filters for molten metals and hot gases, catalytic supports in chemical processing, lightweight structural components, etc. In all these applications, high mechanical strength is desired.

Hydrothermal Synthesis Vs. Other Techniques for AA Whiskers Preparation

AA whiskers can be synthesized by several high-temperature methods. For many decades, the AA whiskers with diameters of a few microns and lengths between a few and tens millimeters, have been prepared by vapor-phase reactions, which involve evaporation of Al metal/alloy or Al₂O₃ in flowing hydrogen atmosphere at 1,300-2,000° C. followed by condensation and whiskers growth. Vapor-liquid-solid deposition was used to synthesized AA whiskers with diameters of 0.5 μm and aspect ratios larger than 1,000 at temperatures of 1,300-1,600° C. in an argon atmosphere in the presence of Ni, Co, Cr, and Fe₂O₃. AA whiskers with diameters of 1-4 μm and length up to a few millimeters were synthesized by the hydrolysis of aluminum fluoride at 1,400° C. under argon gas flow. Sapphire whiskers with 20-60 nm diameters and length up to 10 μm were grown at 900-1,200° C. from thin films of boehmite seeded with AA particles. Formation of AA whiskers was also reported during self-propagating high temperature synthesis (SHS) and by in-situ recrystallization during sintering at 1,000-1,250° C. in the presence of AlF₃. Synthesis of AA long fibers has been accomplished typically by the sol-gel method or by melt growth. All these techniques use high temperatures up to over 2,000° C. and in many cases utilize hazardous gases in order to crystallize AA whiskers or fibers. No low-temperature methods of AA whiskers synthesis have ever been reported.

### Fabrication of Porous AA Ceramics and Fibrous-Porous AA Ceramics

Porous AA ceramics can be prepared by various methods. A typical approach involves the use of equiaxed AA powders, which are formed in the presence of additives using extrusion, molding, or pressing, and subsequently sintered at high temperatures to generate mechanical strength. Usually, high porosity can be obtained by the use of fillers with various shapes (spherical, fibers, etc.) and burn-out materials, which evaporate during processing leaving voids, with controlled size and distribution. In some cases, reinforcements, such as ceramic fibers or platelets, which may or may not be AA, are used to reinforce the porous ceramics. Porous AA ceramics can be also made by sol-gel methods.

Fibrous-porous AA ceramics with improved strength can be fabricated by sintering the AA fibers or whiskers or using them in large concentration as a reinforcement of porous AA ceramics. Fibrous porous materials are known to exhibit improved strength due to interlocking of the fibers, crack deflection and/or pull-out. There are several reports concerning fabrication of fibrous ceramics. Hydroxyapatite porous structures have been prepared by sintering β-Ca(PO₃)₂ fibers with subsequent conversion of the fibrous skeleton into hydroxyapatite by treating in molten salts. Porous calcium phosphates with fibrous microstructure have been made by dynamic compaction of octacalcium phosphate and β-calcium metaphosphate fibers. Highly textured fibrous porous hydroxyapatite ceramics has been prepared by hot pressing of the hydroxyapatite whiskers.

### Hydrothermal Sintering

Another aspect of the present invention is fabrication of ceramic bodies directly under hydrothermal conditions, without using post-synthesis treatments, such as extruding and sintering. Ceramic materials can be consolidated, i.e. sintered, at very low temperatures under hydrothermal conditions. Hydrothermal sintering or hot pressing has become a very simple and most effective fabrication technique for shaped ceramics under mild conditions (temperature of 100-350° C., pressure under 25 MPa), within a short reaction time below 1 hour, often in only one processing step (reactive hydrothermal sintering or hot pressing). The process involves compacting a ceramic powder or its precursor under hydrothermal conditions either in a special hot-pressing apparatus where uniaxial pressure can be applied or simply in a metal capsule. Another possibility is direct hydrothermal sintering of a pressed pellet of powder. During the hydrothermal treatment, mass transport leading to densification occurs mostly by a dissolution-precipitation mechanism. The resulting materials are usually very porous, but exhibit fairly good mechanical properties. However, relative densities as high as 94% have also been reported. Examples of ceramics synthesized and/or densified by this method include zirconia, titania, silica, calcium carbonate, strontium carbonate, magnesium carbonate, hydroxyapatite, glass, and mica. Synthesis of whiskers during hydrothermal sintering results in the formation of fibrous-porous ceramics, like in the case of hydroxyapatite with porosity of 60% and compressive strength of about 20 MPa.

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a process for making a material that includes alpha alumina crystalline whiskers. The process includes conducting the process as hydrothermal, and producing the whiskers to have a length to diameter aspect ratio of at least two.

In accordance with another aspect, the present invention provides a process for making alpha alumina porous ceramic material. The process includes conducting the process as hydrothermal, and producing a fraction of the alpha alumina as interconnected whiskers, with the whiskers having a length to diameter aspect ratio of at least two.

In accordance with another aspect, the present invention provides a high mechanical strength and high porosity porous material including least 90 weight percent alpha alumina and a binder selected from the group ZrO₂, MgSiO₃, CaSiO₃, TiO₂, and SiO₂, and wherein at least a portion of the alpha alumina is configured as whiskers.

In accordance with another aspect, the present invention provides a porous alpha alumina ceramic with a crush strength of above 0.5 MPa.

In accordance with another aspect, the present invention provides a porous alpha alumina ceramic with a pore volume of at least 0.4 cm³/g.

In accordance with another aspect, the present invention provides a porous alpha alumina ceramic with a BET surface area of at least 0.5 m²/g.

In accordance with another aspect, the present invention provides alpha alumina whiskers having diameters in a range from about 0.1 microns to about 10 microns and a length to diameter aspect ratio of at least two.

In accordance with another aspect, the present invention provides alpha alumina whiskers having been treated with acid to remove surface impurities, to create surface roughness or both.

In accordance with another aspect, the present invention provides alpha alumina whiskers having been treated with base to remove surface impurities, to create surface roughness or both.

In accordance with another aspect, the present invention provides alpha alumina whiskers having been treated with a series of solutions that have acidic and basic properties to remove surface impurities, to create surface roughness or both.

In accordance with another aspect, the present invention provides a high mechanical strength and high porosity ceramic including at least one of alpha alumina whiskers or a mixture of alpha alumina whiskers/equiaxed alpha alumina.

### BRIEF DESCRIPTION OF THE DRAWING

The foregoing and other aspects of the present invention will become apparent to those skilled in the art to which the present invention relates upon reading the following description with reference to the accompanying drawings, in which:

FIG. 1 is a schematic diagram of an example autoclave assembly used in hydrothermal synthesis of AA whiskers and porous AA ceramics;

FIG. 2 is an example of typical heating ramps of hydrothermal synthesis of AA whiskers and porous AA ceramics;

FIGS. 3a-3j are SEM photographs of example AA powders and whiskers synthesized hydrothermally in the presence of the following morphology modifiers: (a) none (reference), (b) H₃BO₃ (100 ppm B, Type I), (c) H₃BO₃ (0.1% B, Type III), (d) H₃BO₃ (0.5% B, Type IV), (e) H₃BO₃ (1.0% B, Type V), (f) YCl₃ (0.1% Y, Type VI), (g) H₃BO₃ (0.3% B, Type VIII), (h) H₃BO₃ (0.3% B, Type VIII), (i) H₃BO₃ (0.1% B, Type VII), and (j) H₃BO₃ (0.3% B, Type X), with magnifications noted within the SEM pictures;

FIG. 4 is a graphical plot of example XRD patterns of AA powders and whiskers hydrothermally synthesized in the presence of various concentrations of such morphology modifiers as H₃BO₃ and YCl₃, with corresponding concentrations of modifier metals marked in each case and with each pattern showing pure-phase α-Al₂O₃ (corundum) powders or whiskers;

FIG. 5 is a graphical plot of example intensities of (300) and (110) XRD peaks relative to the strongest (113) peak of the AA phase, as shown in FIG. 4, with increasing concentration of the morphology modifiers, which corresponds to increasing aspect ratio of the whiskers, relative intensity of the (110) peak decreases and relative intensity of the (300) peak increases thus indicating texturing of the AA whiskers (i.e. alignment perpendicular to the applied force) with increasing aspect ratio and thus confirming their single-crystal nature, and with H₃BO₃ and YCl₃ being used as morphology modifiers and corresponding concentrations of modifier metals being marked;

FIG. 6 is a graphical plot of example XPS spectra of the AA whiskers, Type V, prepared in the presence of H₃BO₃ (1.0% B) morphology modifier: surface of the as-synthesized whiskers revealing presence of adsorbed boron at the surface and subsurface region, approximately 100 nm deep, obtained by sputtering argon ions;

FIG. 7 is a graphical plot of example XPS spectra of the AA whiskers, Type VI, prepared in the presence of YCl₃ (0.1% Y) morphology modifier: (a) surface of the as-synthesized whiskers; (b) subsurface region, approximately 100 nm deep, obtained by sputtering argon ions;

FIGS. 8a-8c are photographs showing typical microstructures of the porous AA ceramics (Type B) synthesized hydrothermally in the presence of H₃BO₃ (0.5% B) morphology modifier, with magnifications of (a) 300×, (b) 1,000×, and (c) 3,000×;

FIGS. 9a-9c are plots of typical, example pore size distributions of the fibrous porous AA ceramics synthesized hydrothermally in the presence of the following morphology modifiers: (a) H₃BO₃ (1.0% B), (b) H₃BO₃ (0.5% B), and (c) YCl₃ (0.1% Y);

FIG. 10 graphical plot of example XRD patterns of four types of porous AA ceramics made from hydrothermally synthesized AA whiskers and sintered in air at 1,450° C. (8 hours);

FIGS. 11a-11g are graphical plots showing example pore size distributions of porous AA ceramics made from hydrothermally synthesized AA whiskers for (a) Type 1, sintered in air at 1,450° C. (8 hours), (b) Type 2, sintered in air at 1,450° C. (8 hours), (c) Type 3, sintered in air at 1,450° C. (8 hours), (d) Type 4, sintered in air at 1,450° C. (8 hours), (e) Type 6, sintered in air at 1,400° C. (24 hours), (f) Type 7, sintered in air at 1,450° C. (8 hours), and (g) a comparative example which is composition V-11 disclosed in US 2007/0280877, made from hydrothermally synthesized AA equiaxed powders and sintered in air at 1,450° C. (8 hours);

FIGS. 12a-12g are photographs of example representative microstructures of porous AA ceramics made from hydrothermally synthesized AA whiskers, extruded, and sintered in air at 1,450° C. (8 hours), with (a) Type 2, 100× magnification, (b) Type 2, 1,000× magnification, (c) Type 2, 3,000× magnification, and (d) Type 2, 7,000× magnification, (e) Type 1, 100× magnification, (f) Type 1, 1,000× magnification, (g) Type 1, 3,000× magnification, and (h) Type 1, 5,000× magnification;

FIGS. 13a-13c are SEM photographs revealing microstructures of porous AA ceramics (composition V-11 disclosed in US 2007/0280877) made from hydrothermally synthesized AA equiaxed powders, extruded, and sintered in air at 1,450° C. (8 hours), as a comparative example, with magnifications are: (a) 300×, (b) 1,000×, and (c) 3,000×;

FIG. 14 is a graphical plot of example crush strengths of porous AA ceramics made from equiaxed AA powders or AA whiskers, with or without the presence of boehmite, as a function of total porosity, with all ceramic pieces having the same shape and size and with loading conditions being the same in all cases and with an average from 5-10 measured pieces corresponds to each experimental point, and with the data for AA ceramics made from equiaxed AA powders that were disclosed in US 2007/0280877; and

FIG. 15 is an example plot of XPS spectra of porous AA ceramics made from hydrothermally synthesized AA whiskers and sintered in air at 1,450° C. (8 hours), with the types of the porous AA ceramics marked.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

With regard to Alpha Alumina (Corundum) Whiskers/Fibers and Porous Ceramics—Properties and Applications, it is of great interest to develop methods of inexpensive and environmentally friendly synthesis of the AA whiskers/fibers, which could subsequently be used as reinforcement of AA ceramics. It would be even more advantageous to synthesize the AA whiskers or fibers with very high purity, which is of great interest in a variety of applications. In the present invention we provide for the first time a hydrothermal method to synthesize high-purity AA whiskers in a variety of sizes. We also provide a method to hydrothermally synthesize fibrous porous AA ceramics and use the hydrothermally synthesized AA whiskers of the present invention as reinforcement of porous AA ceramics obtained by sintering. The AA whiskers/fibers of the present invention can be also used in a variety of other applications, for example highly refractory thermal insulations, textured AA ceramics, or as reinforcements of metals in metal-matrix composites.

With regard to Hydrothermal Synthesis vs. Other Techniques for AA Whiskers Preparation, hydrothermal synthesis of AA is a low-temperature, environmentally friendly alternative to the methods described above. Hydrothermal synthesis is a process that utilizes single or heterogeneous phase reactions in aqueous media at elevated temperature (T>25° C.) and pressure (P>100 kPa) to crystallize ceramic materials directly from solution. Hydrothermal synthesis offers many advantages over conventional and non-conventional synthetic methods. There are far fewer time- and energy-consuming processing steps since high-temperature calcination, mixing, and milling steps are either not necessary or significantly reduced. The elimination/reduction of aggregates combined with narrow particle size distributions and excellent morphology control (for example whiskers, cubes, spherical, octahedrons, plates, rods, etc.), which are typical features of powders/whiskers synthesized hydrothermally, leads to optimized and reproducible properties of ceramics because of better microstructure control. Another important advantage of the hydrothermal synthesis is that the purity of the synthesized powders significantly exceeds purity of the starting materials. It is because the hydrothermal crystallization is a self-purifying process, during which the growing crystals/crystallites tend to reject impurities present in the growth environment. The impurities are subsequently removed from the system together with the crystallizing solution, which does not take place during other synthesis routes, for example high-temperature calcination. In addition, materials synthesized under hydrothermal conditions often exhibit differences in point defects when compared to materials prepared by high temperature synthesis methods.

AA powders with a wide range of crystallite sizes, starting from 50 nm or so through large single crystals, with equiaxed or platelet morphology, pure or with dopants, can be synthesized by this method. Size and morphology of the AA synthesized hydrothermally can be controlled by various additives introduced into the crystallization environment. Presence of 0.05-0.1M-H₂SO₄ aqueous solution results in formation of submicron AA crystals (100-250 nm). Use of acids, such as H₃PO₄ or other inorganic acids is known to control the size and also the morphology of the AA crystallites, for example to induce plate-like morphology. Conversely, use of CrCl₃ or KMnO₄ in order to introduce doping elements of Cr and Mn in concentrations of 0.01%, and 0.05%, respectively, did not result in any modifications of the AA crystals size or morphology. However, no additives have ever been reported to yield elongated AA crystals (whiskers) during hydrothermal synthesis.

To the best knowledge of the inventors, no whiskers or fibers of AA have ever been synthesized by the hydrothermal method or by any related technique. Therefore, it would be advantageous to use the hydrothermal synthesis to prepare AA whiskers or fibers, with high aspect ratios, which could be then used for a variety of applications, including fabrication of fibrous-porous AA ceramics. Unique elongated morphology of crystals (i.e. whiskers) combined with high chemical purity and unique defect structure of hydrothermally synthesized alpha-alumina AA could be very attractive features in a variety of applications.

With regard to Fabrication of Porous AA Ceramics and Fibrous-Porous AA Ceramics, the inventors have used hydrothermally synthesized AA and AA/boehmite equiaxed powders as starting materials to fabricate porous AA ceramics for catalytic supports in ethylene oxide (EO) catalysis. It would be advantageous to use the hydrothermally synthesized AA whiskers of the present invention to fabricate high-strength fibrous-porous AA ceramics for a variety of applications including catalyst supports. The use of hydrothermally synthesized whiskers offers here several advantages, such as high chemical purity of AA, precise control of AA size and morphology resulting in precise and unique microstructure control (including unique pore size distributions), as well as possibly different chemical defect structures of AA due to unique features of process described in the present invention. However, to the best knowledge of the inventors, no high-strength/high-purity fibrous porous AA ceramics has ever been fabricated from the AA whiskers.

With regard hydrothermal sintering, to the best knowledge of the inventors, no AA whiskers or fibers have ever been hot pressed, sintered or reactively sintered under hydrothermal conditions, neither type of fibrous porous AA ceramics has ever been fabricated under hydrothermal conditions. It would be advantageous to use the hydrothermal synthesis to fabricate fibrous porous AA ceramics, which could be then used for a variety of applications.

### Hydrothermal Synthesis of AA Whiskers and AA Porous Ceramics Starting Materials

The selection of appropriate precursor, seeds, morphology modifiers and chemical additives for the hydrothermal synthesis of AA whiskers and porous AA ceramics is part of the process to obtain products with desired properties, such as chemical purity, crystallite morphology, crystal size, aggregation level, porosity, pore size distribution, specific surface area, etc.

Aluminum tri-hydroxide (trihydrate) powder (gibbsite or hydrargillite, chemical formula Al(OH)₃) can be used as a precursor powder in hydrothermal synthesis of AA whiskers and porous AA ceramics. Available typical properties of the precursor powder (Precursor Type A) are summarized in Table I. Other grades or types of gibbsite or hydrargillite powders, as well as other aluminum tri-hydroxides or oxide-hydroxides, such as boehmite (chemical formula AlOOH), bayerite (Al(OH)₃), nordstrandite (Al(OH)₃), diaspore (AlOOH), pseudobehmite, transition aluminas, or even amorphous phases can be also used as precursors in hydrothermal synthesis of AA whiskers and porous AA ceramics, however, their use is outside of the scope of the present invention.

TABLE I
Physicochemical properties of the precursor powder for hydrothermal
synthesis of AA whiskers and porous AA ceramics

| Property | Precursor Type A |
|---|---|
| Al₂O₃ (%) | 65.0 |
| Total Na₂O (%) | 0.1 |
| Soluble Na₂O (%) | 0.01 |
| Fe₂O₃ (%) | 0.01 |
| SiO₂ (%) | 0.005 |
| Free Moisture (%) | 0.05 |
| Specific Gravity (g/cm³) | 2.42 |
| Refractive Index (—) | 1.57 |
| Grit + 325 mesh (%) | 10-30 |
| Median Particle Size (μm) | 25 (average) |
| Specific Surface Area (m²/g) | — |

An alternative to aluminum tri-hydroxides or oxide-hydroxides precursors can be aqueous solutions of aluminum salts, such as Al(NO₃)₃, AlCl₃, Al₂(SO₄)₃, etc., which can form AA during hydrothermal synthesis under either basic or acidic conditions, and in one example in the presence of AA seeds, and/or other additives.

The aluminum hydroxide precursor powders often contain trace quantities of organic impurities, such as humic acids and related compounds, which are residues from the raw materials and/or fabrication process, i.e. the Bayer process, which utilizes naturally occurring bauxite ore as starting material. The presence of organic substances, quantities of which can vary from lot to lot of Al(OH)₃, may result in “organic” odor after the hydrothermal synthesis and/or gray color of the synthesized AA whiskers and porous AA ceramics. These organic impurities could also interfere with the crystallization process of AA. In some cases, the organic residues can be eliminated by heating the AA whiskers and porous AA ceramics after synthesis in air atmosphere in order to burn-out the organics. Such process, however, is not very efficient for large-scale hydrothermal production of AA whiskers and porous AA ceramics.

One treatment approach is the use of selected amounts of hydrogen peroxide (H₂O₂), which are added to the precursor before the hydrothermal treatment. H₂O₂ is a known oxidizer for organics, particularly in aqueous solutions (formation of active HO^{.} radicals) and under hydrothermal conditions (decomposition with formation of oxygen and water). During the hydrothermal treatment, the hydrocarbons decompose into CO₂ and H₂O. Addition of H₂O₂ was thus found to be very efficient in elimination of gray color and odor by decomposing the organic impurities, without affecting any of the properties of the AA whiskers and porous AA ceramics.

Seeds can be advantageously used to control the size, composition and rate of crystallization of oxides under hydrothermal conditions. The relationship between the AA seeds used as starting materials and the final AA hydrothermal products is a complex function of seed quantity (weight/volume fraction of seeds with respect to the precursor), particle size, aggregation level, and type of seeds, as well as type of precursor, conditions of the hydrothermal synthesis, and method of mixing the seeds with the precursor. This complex relationship has to be established experimentally in each case. Crystal habits can be significantly changed by various species, which can adsorb on some certain facets of the growing crystals, blocking growth in certain directions, thus acting as morphology modifiers.

A variety of adsorbing species have been reported to adsorb on AA crystals. Titanium, aluminum, niobium, nickel, iron, copper, silver, palladium, platinum, and rhodium have been reported to adsorb on α-Al₂O₃ (0001) surfaces, germanium on α-Al₂O₃ (10-12) surfaces. Phenanthrene, pyrene, and butane can adsorb onto (11-20) and (0001) surfaces of α-Al₂O₃ single crystals, CO on α-Al₂O₃ (0001) surfaces.

Without determining specific adsorption surfaces, adsorption of the following cations, anions, and organic species on α-Al₂O₃ have been reported: cadmium, cobalt, copper, neptunium, uranium, zinc, barium, manganese, radium, arsenate (III, V), benzoate, chloroplatinate, chromate, citrate, fluoride, molybdate, phosphate, silicate, selenate, tricarballylic acid, albumin, fulvic acid, glutamic acid, phenol, and therelike.

In addition, adsorption of the following cations, anions, and organic species on other forms of Al₂O₃ including α-Al₂O₃ or γ-AlOOH have been reported (no adsorption surfaces determination): barium, calcium, magnesium, strontium, cadmium, manganese, vanadium, iron, zinc, gallium, indium, gadolinium, yttrium, cobalt, chromium, copper, nickel, lead, palladium, plutonium, uranium, americium, europium, neptunium, borate, carbonate, chloroplatinate, chromate, citrate, EDTA, fluoride, molybdate, NTA, phenylphosphonic acid, phosphate, phthalate, rhenate, salicylate, sulfate, thiosulfate, acetate, benzoate, selenate, cacodylate, methyl arsenate, CDTA, DTPA, EGTA, HEDTA, TTHA, clodronate, phenyl phosphonate, fumarate, maleate, succinate, benzoic acid, arsenate, silicate, vanadate, oxalate, catechol, dinitrophenol, organic carbon, fulvic acid, glutamic acid, humic acid, methylene blue, nicotinate, chlorophenols, phenylalanine, tyrosine, phenols, amines, nitrobenzenes, nitrophenols, alanine, hydroquinone, and therelike.

Some sources of morphology modifiers can be their aqueous solutions. It is presumed that any type of chemicals can be used, providing that they do not introduce unwanted impurities, which could result in undesired properties of the AA whiskers and porous AA ceramics. The morphology modifiers can also be used to dope the AA crystals with a variety of desired elements, or to change the crystal size, aggregation level, and size distributions.

### Hydrothermal Synthesis

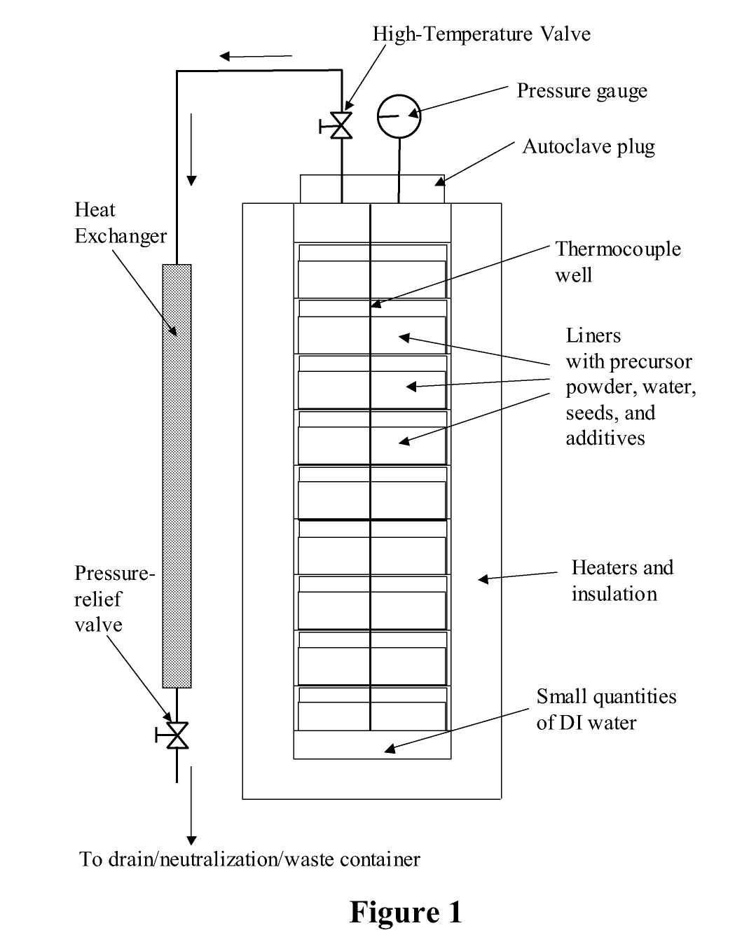

The hydrothermal synthesis of AA whiskers and porous AA ceramics takes place in a hermetically closed autoclave (pressure vessel, reactor), with at least one thermocouple, temperature controller(s), at least one pressure gauge, with a pressure relief system designed to vent excess pressure during synthesis (FIG. 1). Materials of construction of the autoclave can be any materials, which can withstand operating temperatures and pressure in multiple cycles of AA synthesis.

In a key embodiment of the present invention, the autoclave is filled with several liners, stacked one on another (FIG. 1). The liners may be used to control contamination of the products and/or protect the autoclave from chemical attack. The liners have a central opening allowing inserting thermocouples for temperature measurements and/or control. The material of the liners can by of any type, providing that it does not introduce impurities (chemical, particulate), which can deteriorate the properties of the AA whiskers and porous AA ceramics. In some cases, however, the liner material can also be used to modify the properties of the AA whiskers and porous AA ceramics (chemical composition, size, morphology, aggregation level, size distribution). One type of the material of the liner is pure titanium metal, such as Grade 2 titanium. The liner can be formed by molding and/or welding of metal sheets and/or pipes. Both the interior and the exterior of each liner, including new liners, should be cleaned to avoid incorporation of any undesired impurities in the AA product. The load in each liner can be the same or can be different than in the other liners. This allows for synthesis of various types of AA whiskers and porous AA ceramics in the liners within the same high-pressure reactor all made under the same T and P and heating and cooling routines.

A general procedure to fill each liner is as follows: (1) adding DI water to each Ti metal liner to reach desired weight or volume; (2) adding appropriate weight/volume of the H₂O₂ and stirring thoroughly in order to obtain homogeneous solution; (3) adding desired weight/volume of chemical additive(s) and/or morphology modifiers, and stirring thoroughly in order to obtain homogeneous solution/suspension; (4) adding appropriate weight of the precursor powder followed by stirring the container to obtain uniform slurry (if uniform slurry cannot be obtained, more water is added); (5) adding the seeds and stirring the container for several minutes in order to disperse the seeds uniformly in the slurry; (6) covering the liner with a lid and positioning in the autoclave. Loading of the liners into the autoclave is preceded with cleaning the autoclave to remove any visible contaminants, followed by thorough rinsing with DI water. The liners are positioned on special supports, which allow simultaneous loading/unloading of 1-5 liners at the same time. The bottom of the autoclave is filled with DI water (below the liners), to generate initial pressure in the autoclave during the hydrothermal synthesis. The amounts of water vary and depend upon total water content in the autoclave (calculated as a sum of water in the liners and water from decomposition of the precursors). It should be minimized so during heating up level of water in the bottom does not increase due to expansion to fill the containers (see FIG. 1). The time lag between completing loading the liners and starting the heat treatment in the hermetically closed autoclave is several hours. The heat treatment of the hydrothermal synthesis is selected by those skilled in the art from phase diagrams in the Al₂O₃—H₂O system.

The following reactions take place under hydrothermal conditions to make AA from alumina hydrates:

Al(OH)₃→AlOOH+H₂O (1)

2AlOOH→α-Al₂O₃(AA)+H₂O (2)

Reaction (1) can occur above ≈100° C. practically independently of the water vapor pressure. Reaction (2) can occur above ≈350° C. up to ≈450° C., but only at pressures not exceeding ≈15 MPa (≈2,200 psi), because of the presence of AlOOH (diaspore)-stability region, which extends from 270° C. to 450° C. and from ≈15 MPa to over 100 MPa. In addition to raw materials and reactor design, very specific time, temperature and pressure “ramps” are required to produce AA whiskers and porous AA ceramics of the desired characteristics. Due to constraints imposed by the strength of the autoclave, conducting synthesis above 450° C. at high pressure does not seem to be practical. Therefore, at AA synthesis temperatures below 450° C. (practical range is 380-430° C.), the pressure is reduced to or below ≈15 MPa (≈2,200 psi). In order to achieve this objective, water vapor pressure is released simultaneously with increasing temperature in the autoclave.

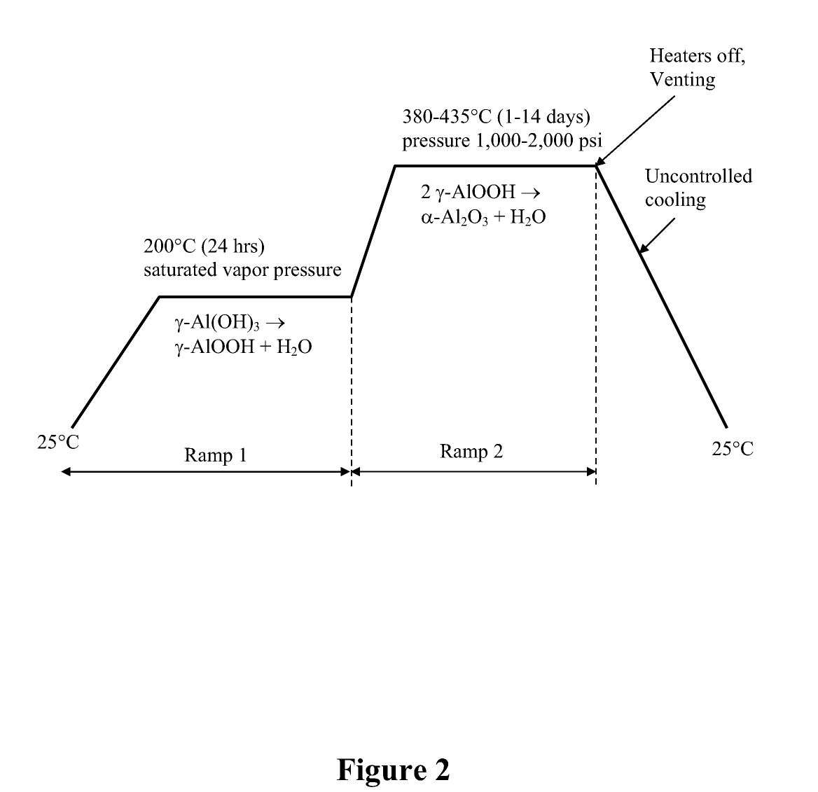

In a key embodiment of the present invention, the ramps of the hydrothermal heat treatment in synthesis of AA whiskers and porous AA ceramics are as follows (FIG. 2): Ramp 1: from room temperature to 200° C. with a heating rate of 11.7° C./hr, followed by holding at 200° C. for 24 hours with temperature stability of a few ° C., with pressure being equal to the saturated vapor pressure of water at this temperature; Ramp 2: 200° C.—Maximum Temperature with a heating rate of 9.0-23.3° C./hr, followed by holding at Maximum Temperature for 1-14 days, with temperature stability of a few ° C., with pressure not exceeding about 3,000 psi. The Maximum Temperature is between 380° C. and 430° C. Such ramps selection enables synthesis of AA whiskers and porous AA ceramics. Selection of other ramps is possible to synthesize AA, as described in.

In all cases of AA synthesis, during the hydrothermal heat treatment, when the autoclave is ramping up towards the Maximum Temperature, when the temperature increases above 300° C. (saturated vapor pressure of water is 1246 psi at 300° C.), the pressure relief procedure is initiated in order to keep the pressure at levels enabling AA synthesis. The high-temperature valve is open so the steam can be vented through the heat exchanger (FIG. 1). Use of a regular valve will result in a leak due to very high temperature of the steam exiting the autoclave (300° C.-450° C.). Pressure is controlled using the pressure-relief valve located at the end of the venting system, which prevents excessive reduction of pressure in the autoclave (re-sealing pressure above 1,000 psi). The heat exchanger can use any cooling medium provided that it can cool steam from temperatures between 300° C. and above 430° C., to well below the boiling point of water, such as to the room temperature.

After completing the hydrothermal synthesis of AA whiskers and porous AA ceramics (one of the indications of completing the reaction is stable pressure at constant temperature), the autoclave can be either naturally cooled down to room temperature, with subsequent drying of the synthesized powders in an oven above 100° C. or the autoclave can be vented while still at high temperature. The venting involves opening the high-temperature valve and bypassing the pressure-relief valve. The entire water present the autoclave at the end of the hydrothermal synthesis is vented either directly to the drain or to the neutralization tank. If toxic additives are present, the entire content of the autoclave is collected in a drum and subsequently disposed according to local/state/government regulations.

When the autoclave cools down to a temperature close to room temperature, it can be opened. If venting was applied, the powders are usually dry. After opening and unloading the liners with synthesized AA whiskers and porous AA ceramics inside, the autoclave is cleaned from any residues. Contents of every liner are briefly inspected by optical microscopy in order to confirm crystal size and phase purity of the AA whiskers and porous AA ceramics. This practice prevents mixing good and lower quality material or powders with different characteristics, if any.

In each liner, top layer of powder with a thickness of at least ¼″ is removed and discarded. The very top part of the powder tends to accumulate impurities, particularly sodium, iron, and silica. The remaining content of each liner can be collected in a fiber drum (or pail) as good material, however at least ¼″ of material attached to the walls and to the bottom of the container is left in the container and subsequently discarded. This part of the powder tends to accumulate impurities as well, particularly sodium, iron, and silica. An alternative way to avoid materials removal is to use improved liner design, which includes a double bottom and a top screen, which can collect the top and bottom impurities.

Preparation of Porous AA Ceramics from AA Whiskers by Extrusion and Sintering

As-synthesized (i.e. aggregated) AA whiskers or AA whiskers/boehmite mixtures or AA whiskers/equiaxed AA mixtures, prepared under hydrothermal conditions, can be used as starting materials in preparation of porous AA ceramics. The porous AA ceramics can be made by simple sieving or compaction of powders containing the AA whiskers with or without sintering additives, with or without binders with or without subsequent heat treatments. In one example, the porous AA ceramics are made by forming extrudates which are subjected to subsequent heat treatments used to generate desirable mechanical strengths.

Extrudates containing AA whiskers or their mixtures with boehmite or equiaxed AA powders can be formed by adaptation of processes, known in the open literature.

In one embodiment of the present invention, the extrudates are made without any binders (i.e. sintering additives), by mixing hydrothermally synthesized AA whiskers, AA whiskers/boehmite, or AA whiskers/equiaxed AA powders possibly with water or a sufficient amount of burnout material (f. e. petroleum jelly, polyvinyl alcohol, etc.) using a blender, mixer, or mill, etc. and forming the extrudate using an extruding apparatus.

In another embodiment of the present invention, the extrudates are made by mixing hydrothermally synthesized AA whiskers, AA whiskers/boehmite, or AA whiskers/equiaxed AA powders with sufficient amount of Cs salts, such as carbonate, hydroxide, aluminate, sulfate, etc., used as binders (i.e. sintering additives), and sufficient amounts of burnout material(s) (f. e. water, petroleum jelly, polyvinyl alcohol, etc.) using a blender, mixer, or mill, etc. and forming the extrudate using an extruding apparatus.

In another embodiment of the present invention, the extrudates are made by mixing hydrothermally synthesized AA whiskers, AA whiskers/boehmite, or AA whiskers/equiaxed AA powders with sufficient amount of binders (i.e. sintering additives), such as TiO₂, ZrO₂, SiO₂, Mg Silicate, CaSilicate or their mixtures, and sufficient amounts of burnout material(s) (f. e. petroleum jelly, polyvinyl alcohol, etc.) using a blender, mixer, or mill, etc. and forming the extrudate using an extruding apparatus. The sintering-enhancing elements used in binders, such as Ti, Zr, Si, Mg, Ca, etc., or their mixtures, can be also incorporated in AA whiskers during the hydrothermal synthesis by doping.

In one example embodiment of the present invention, the extrudates are made by mixing hydrothermally synthesized AA whiskers, AA whiskers/boehmite, or AA whiskers/equiaxed AA powders with sufficient amount of boehmite used as binder (i.e. sintering additive), and sufficient amounts of burnout material(s) (f. e. water, petroleum jelly, etc.) using a blender, mixer, or mill, etc. and forming the extrudate using an extruding apparatus.

Appropriate extruding apparatus can be used to prepare the extrudate, for instance extruders manufactured by The Bonnot Company, Uniontown, Ohio. The diameter of the extrudate can be as small as 1/32″, the applied pressure can range between 100 and 3,000 psi or so. The conditions of forming the extrudate, as well as amounts and types of the binders and burnout materials, are determined experimentally for each type of AA whiskers, AA whiskers/boehmite, or AA whiskers/equiaxed AA powders, in order to yield optimum properties of the AA porous ceramics after subsequent heat treatment.

The heat treatment of the extrudates involves slow removal of water and other volatile matter between the room temperature and 200° C., removal of burnout materials, if any, up to 500° C., and finally building the strength of the porous support at temperatures up to 1,600° C. (e.g., up to 1,450° C.) together with transformation of boehmite, if any, into AA phase above 1,100° C. The heat ramp(s), including temperatures, durations, and heating rates during the extrudate heat treatment are selected to obtain desired mechanical strength and microstructure of the support, and are developed experimentally in each particular case.

The porous AA ceramics obtained by the heat treatment of AA whiskers, AA whiskers/boehmite, or AA whiskers/equiaxed AA powders extrudates with or without additives described above, can be used for a variety of applications.

### Materials Characterization

Phase composition of precursor powders, whiskers after the hydrothermal synthesis, and porous AA ceramics (after crushing it and grinding into powder), was characterized by X-ray diffraction using Advanced Diffraction System X1 diffractometer (XRD, Scintag Inc.) using Cu K_{α} radiation, in the range between 10-70° with a 0.05° step size and 0.3-0.7 s count time. The chemical identity of the materials was determined by comparing the experimental XRD patterns to standards compiled by the Joint Committee on Powder Diffraction and Standards (JCPDS), i.e. card #10-0173 for α-Al₂O₃ (corundum, AA) and #03-0066 for γ-AlOOH (boehmite).

The morphology and phase purity of the AA whiskers, as well as microstructures and fracture surfaces of porous AA ceramics, were examined using both optical microscope (Vanox, Olympus, Tokyo, Japan) under 50-500× magnifications and a scanning electron microscope (SEM, Model S-4500, Hitachi, Japan) at 5 kV accelerating voltage. Prior to the SEM examination, the materials were attached to aluminum holders using a conductive carbon tape and subsequently sputtered with thin conductive layers of palladium. Sizes, i.e. diameters, lengths, and aspect ratios of AA whiskers were measured from SEM photographs.

Chemical compositions in the AA whiskers and porous AA ceramics were determined using DC Arc and ICP-MS methods at NSL Analytical (Cleveland, Ohio). The AA materials were analyzed for the following elements (detection limits in brackets): Na (10 ppm), Si (10 ppm), Ca (10 ppm), Mg (10 ppm), Fe (10 ppm), B (10 ppm), and Y (10 ppm).

Chemical moieties present on the surface of the AA whiskers and porous AA ceramics were determined using X-ray photoelectron spectroscopy (XPS) using the Phi 5600 ESCA system. The AA whiskers were attached to the holders using conductive carbon tape. Porous AA ceramics were broken into small pieces and only fracture surfaces were analyzed. The XPS spectra were acquired from the surface areas with diameters of approximately 1 mm on each sample. Only one spot on each sample was analyzed by this technique. In a typical XPS measurement, a 20-60 min. overview scans were performed in the binding energy range of 0-1,100 eV.

Specific surface areas (BET) of selected AA whiskers and porous AA ceramics were measured from 40-point BET nitrogen adsorption isotherm at Micromeritics Analytical Services (Norcross, Ga.) or from 5-point BET nitrogen adsorption isotherm in the range of relative pressures (p/pₒ) between 0.07 and 0.24 using Nova 1200e equipment (Quantachrome Inst., FL).

Pore volumes and pore size distributions of the porous AA ceramics were measured using mercury intrusion porosimeter (Model Poremaster 60, Quantachrome Inst., FL, pore sizes range of 3 nm-200 μm).

Porosities and pore volumes of the porous AA ceramics were measured from water absorption data and corresponding masses at room temperature, assuming absence of closed (i.e. impenetrable) pores. The water absorption tests of porous AA ceramics were performed by slowly immersing the AA ceramics of a known weight in DI water, heating the water close to the boiling point for 1 hour in order to remove any air entrapped in the pores, and finally measuring the weight of the wet AA ceramics after the water has cooled down to the room temperature. Comparison of the mass of the carriers in dry and wet state allowed calculations of the open porosity (volume % units) pore volume (cm³/g units) and water absorption (% units).

Crush strength of the porous AA ceramics was measured using a hydraulic press attached to a calibrated heavy-duty electronic balance. In each measurement, AA ceramics was placed on a flat surface of the electronic balance and was slowly pressed by a steel plate mounted to a hand-operated hydraulic press. The symmetry axis of the porous AA ceramics was always parallel to the metal surfaces, i.e. the load was applied in the direction perpendicular to the symmetry axis of the ceramic extrudate. The load under which the support has cracked was recorded and used for calculations of the crush strength. Total of 5-10 pieces with the same size were crushed that way, in order to calculate the average and minimum crush strength for each type of porous AA ceramics.

### Results and Discussion

### Hydrothermal Synthesis of AA Whiskers/Fibers

Typical physicochemical properties of the AA whiskers synthesized by the hydrothermal method, such as lengths, diameters, aspect ratios, morphologies, chemical and phase purities, and BET specific surface areas are summarized in Table II. For comparison, properties of an equiaxed AA powder synthesized under similar conditions are also shown in Table II. The AA whiskers exhibit a combination of high phase and chemical purity with unique morphology, which make them fibers of choice for a variety of applications.

TABLE II
Typical physicochemical properties of AA whiskers synthesized by the hydrothermal method

| | Equiaxed | | | | | | | | |
|---|---|---|---|---|---|---|---|---|---|
| | Powder | | “Elongated” | Whiskers | Whiskers | | Whiskers | Whiskers | Whiskers |
| Property | (reference) | | Type I | Type II | Type III | | Type IV | Type V | Type VI |
| Morphology | None | | H₃BO₃ | H₃BO₃ | H₃BO₃ | | H₃BO₃ | H₃BO₃ | YCl₃ |
| Modifier | | | (100 ppm B) | (500 ppm B) | (0.1% B) | | (0.5% B) | (1.0% B) | (0.1% Y) |
| (concentration) | | | | | | | | | |
| Whisker | N/A | | ~2 | ~3 | 2-4 | | 2-12 | 4-7 | 4-10 |
| Aspect Ratio | | | | | | | | | |
| (—) | | | | | | | | | |
| Whisker | 2-4 | | ~5 | 4-5 | 3-5 | | 0.5-2.0 | 0.5-2.0 | 0.3-1.0 |
| Diameter | | | | | | | | | |
| (μm) | | | | | | | | | |
| Whisker | N/A | | ~10 | 10-15 | 6-15 | | 1-10 | 2-6 | 2-6 |
| Length | | | | | | | | | |
| (μm) | | | | | | | | | |
| Powder | Equiaxed | | Elongated + | Whiskers + | Whiskers+ | | Whiskers + | Whiskers | Whiskers |
| Morphology | crystals, | | equiaxed | equiaxed | equiaxed | | equiaxed | only, | only, |
| | aggregated | | (1-3 μm), | (2-4 μm diameter), | (1-2 μm), | | (0.3-1.0 μm), | aggregated | aggregated |
| | | | aggregated | aggregated | aggregated | | aggregated | | |
| Crystal | 92% α-Al₂O₃ + | | 100% α-Al₂O₃ | 100% α-Al₂O₃ | 100% α-Al₂O₃ | | 100% α-Al₂O₃ | 100% α-Al₂O₃ | 100% α-Al₂O₃ |
| form | 8% γ-AlOOH | | | | | | | | |
| Chemical | >99.9 | | >99.9 | >99.9 | >99.9 | | 99.9 | >99.8 | >99.8 |
| purity (% ) | | | | | | | | | |
| Surface | 0.77 | | — | — | 0.56 | | 1.14 | 1.39 | 1.36 |
| area, BET | | | | | | | | | |
| (m²/g) | | | | | | | | | |
| Impurities | <10 | ppm | <50 ppm | <50 ppm | 30 | ppm | 20 ppm | 30 ppm | 10 ppm |
| Si | | | | | | | | | |
| Na | 20-140 | ppm | 40 ppm | 70 ppm | 50-170 | ppm | 170 ppm | 200 ppm | 110 ppm |
| Fe | 20-50 | ppm | 40 ppm | 50 ppm | 30-50 | ppm | 50 ppm | 50 ppm | 50 ppm |
| Mg | <10 | ppm | <10 ppm | <10 ppm | <10 | ppm | <10 ppm | <10 ppm | <10 ppm |
| Ca | 20-40 | ppm | 50 ppm | 50 ppm | 30-50 | ppm | 30 ppm | 30 ppm | 30 ppm |
| B | <10 | ppm | <10 ppm | 40 ppm | 60-170 | ppm | 550 ppm | 730 ppm | 40 ppm |

| | | | | | | | | |
|---|---|---|---|---|---|---|---|---|
| Y | <10 | ppm | — | — | — | — | — | 950 ppm |

| | Equiaxed | | | | | |
|---|---|---|---|---|---|---|
| | Powder | Whiskers | Whiskers | Whiskers | Whiskers | Whiskers |
| Property | (reference) | Type VII | Type VIII | Type IX | Type X | Type XI |
| Morphology | None | H₃BO₃ | H₃BO₃ | H₃BO₃ | H₃BO₃ | H₃BO₃ |
| Modifier | | (0.1% ppm B) | (0.3% ppm B) | (0.1% B) | (0.3% B) | (0.5% B) |
| (concentration) | | | | | | |
| Whisker | N/A | 2-4 | 3-6 | 2-5 | 3-6 | 3-6 |
| Aspect Ratio | | | | | | |
| (—) | | | | | | |
| Whisker | 2-4 | ~7 | 5-7 | 5-7 | 5-7 | 3-5 |
| Diameter | | | | | | |
| (μm) | | | | | | |
| Whisker | N/A | 12-25 | 20-30 | 15-25 | 20-30 | 15-20 |
| Length | | | | | | |
| (μm) | | | | | | |
| Powder | Equiaxed | Whiskers | Whiskers | Whiskers | Whiskers | Whiskers |
| Morphology | crystals, | only, | only, weakly | only, | (α-Al₂O₃) + | (α-Al₂O₃) + |
| | aggregated | aggregated | aggregated | aggregated | equiaxed | equiaxed |
| | | | | | (1 μm γ-AlOOH), | (1 μm γ-AlOOH), |
| | | | | | aggregated | aggregated |
| Crystal | 92% α-Al₂O₃ + | 100% α-Al₂O₃ | 100% α-Al₂O₃ | 100% α-Al₂O₃ | α-Al₂O₃ (>>) + | γ-AlOOH (>) + |
| form | 8% γ-AlOOH | | | | γ-AlOOH | α-Al₂O₃ (<) |
| | | | | | (<<) | |
| Chemical | >99.9 | >99.9 | 99.9 | >99.9 | >99.9 | 99.9 |
| purity (% ) | | | | | | |
| Surface | 0.77 | — | — | — | — | — |
| area, BET | | | | | | |
| (m²/g) | | | | | | |
| Impurities | <10 ppm | 20 ppm | 20 ppm | 20 ppm | 20 ppm | — |
| Si | | | | | | |
| Na | 20-140 ppm | 110 ppm | 160 ppm | 110 ppm | 130 ppm | — |
| Fe | 20-50 ppm | 50 ppm | 40 ppm | 50 ppm | 50 ppm | |
| Mg | <10 ppm | <10 ppm | <10 ppm | <10 ppm | <10 ppm | |
| Ca | 20-40 ppm | 20 ppm | 20 ppm | 20 ppm | 30 ppm | |
| B | <10 ppm | 130 ppm | 390 ppm | 170 ppm | 180 ppm | |

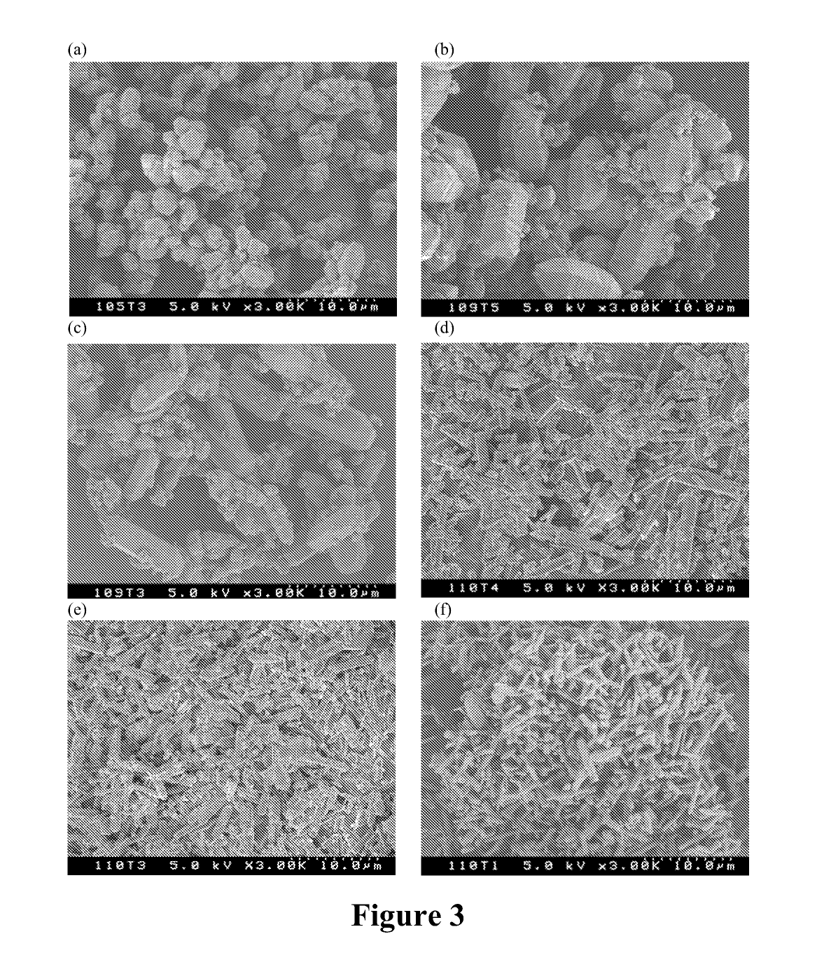

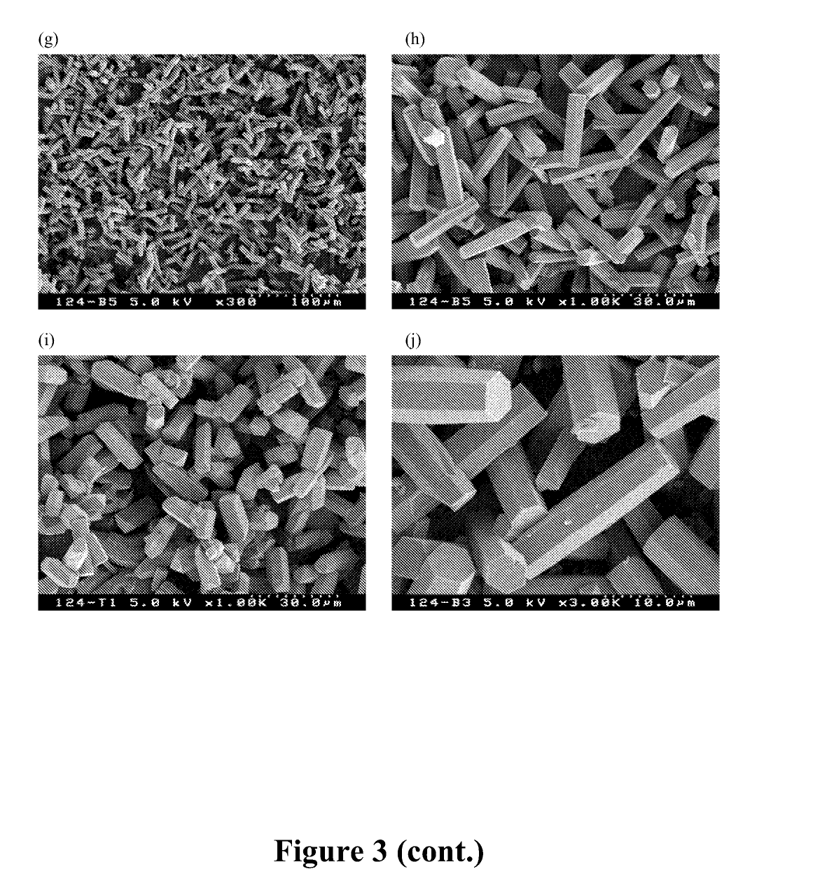

SEM photographs shown in FIG. 3(b)-(j) reveal typical morphologies of the AA whiskers. The individual crystallites exhibit various levels of aggregation, depending upon the whisker type. All of the whiskers are very well defined elongated single crystals of the AA phase with well-developed crystal facets (FIG. 3j). Each whisker is a single crystal of the AA phase elongated along the crystallographic c-axis. Aspect ratio of the AA whiskers range between 2 and 12, their diameters are between 0.3 μm and 7 μm, lengths are between 2 μm and 30 μm (see also Table II, FIG. 3). Whiskers of Type I-IV (FIG. 3(b)-(d), Table II) contain various fractions of equiaxed AA crystals, with diameters between 0.3 μm and 4 μm. Whiskers of Type X-XI contain various fractions of boehmite.

Chemical purity of the AA whiskers is comparable to the chemical purity of the equiaxed AA powders, synthesized under similar conditions and is over 99.9% for the equiaxed AA powder and between >99.8% and >99.9% for the AA whiskers. Slightly lower chemical purity is caused by the uptake of metals from the morphology modifiers, such as yttrium and boron (Table II).

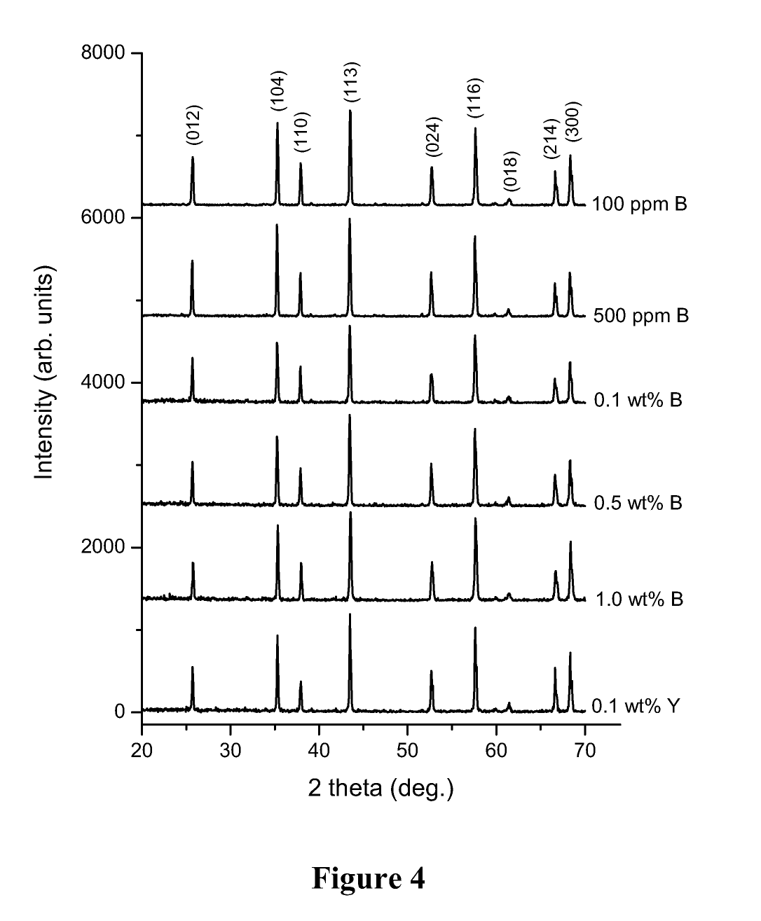

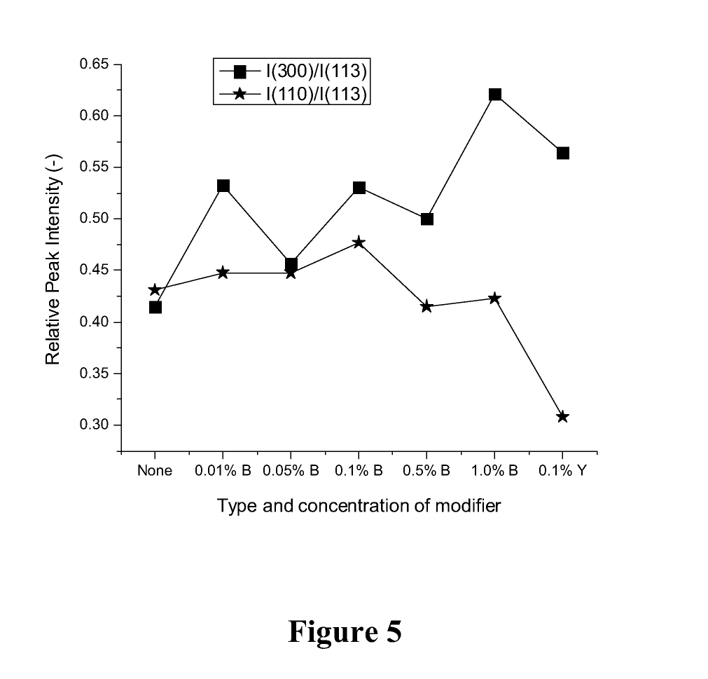

Phase purity of the AA whiskers is 100% in each case. As shown in FIG. 4, no XRD peaks other than those derived from the α-Al₂O₃ (corundum) phase were observed in all types of the AA whiskers. FIG. 5 shows that with increasing aspect ratio of the whiskers, relative intensity of the (110) peak decreases and relative intensity of the (300) peak increases. The AA whiskers are elongated along the c-axis, thus such peak intensity ratio change indicates texturing of the whiskers (i.e. alignment perpendicular to the applied force) with increasing aspect ratio. It also confirms the single-crystal nature of the AA whiskers.

The conversion to the AA phase can be complete, as described above, or limited. Several factors, such as lower temperature, shorter synthesis time, special conditions of the first ramp in dual-ramp hydrothermal heat treatment, etc., can be used to make unique AA whiskers in combination with various quantities of γ-AlOOH (boehmite) attached to the AA surface. Content of boehmite could vary from 0.01% to 100% (completely unreacted). These special conditions can be applied to produce very unique mixtures of boehmite and AA whiskers of different morphologies and different mass ratios of AA/boehmite. Examples of such mixtures are presented in Example 9-11. Other examples of hydrothermally synthesized AA/boehmite equiaxed powder mixtures were shown elsewhere.

The AA whiskers of the present invention (see Examples 1-11) are well suited for a variety of demanding applications, such as use in porous or dense ceramic-matrix composites as reinforcing fibers, fabrication of textured α-Al₂O₃ ceramics, fibrous-porous ceramics, refractory thermal insulations, reinforcements of in metal-matrix composites, production of catalysts supports or carriers, etc.

### Effects of Basic Process Parameters of the Hydrothermal Synthesis

Effects of parameters of the hydrothermal synthesis of AA, such as the synthesis temperature, time, pressure, heating rate, ramp durations, seed concentration, etc., have been described in detail elsewhere. Some of these effects are summarized below. Effects of the hydrothermal synthesis parameters were not studied in detail in the case of AA whiskers synthesis. Nevertheless, it is believed that the relationships established in the previous work on equiaxed powders synthesis still work in AA whiskers synthesis.

In the hydrothermal process of our invention, no AA phase is observed to form when the synthesis temperature is lower than 380° C. even in the presence of large fraction of seeds. It is believed that stability region of AA extends to at least 500° C. Increasing temperature reduces time necessary to full conversion of the precursor into AA. Powders, which did not achieve 100% conversion into AA, consisted of unique mixtures of AA and γ-AlOOH (boehmite).

In the hydrothermal process of our invention, with increasing time of the hydrothermal synthesis, conversion to AA is more complete. The shortest time to achieve 100% conversion is about 1 day, the longest about 14 days. Presence of seeds reduced the synthesis time. No effects of the synthesis time on sizes of the AA crystals were observed. Typical pressure range for the hydrothermal synthesis of AA is 1,000-2,000 psi. The minimum and maximum measured pressures, which allowed AA synthesis, were 650±100 psi and 2,700±100 psi, respectively. The heating rate was found to be very important factor governing uniformity of the as-synthesized AA crystals. The optimum conditions for Ramp 1 (FIG. 2) were experimentally established at 200° C. for about 24 hours. Temperatures higher than 200° C. resulted in higher tendency to form AA/boehmite mixtures.

The AA seeds were found to be among the most effective modifiers of the crystallite size of AA crystals synthesized hydrothermally. The smaller the AA seeds, the higher their concentration, and the more uniformly they are distributed in the precursor, the finer the hydrothermally synthesized AA crystallites. Contents of seeds required to significantly reducing crystallite size of AA ranged between 0.05% and 12.0%, although higher contents of seeds could be used as well. Effect of seeds in the present invention is clearly visible in FIG. 3. Pure phase AA whiskers (Type V-VI), which were synthesized in the presence of 9 wt. % of 1 μm AA seeds have diameters of 0.3-2.0 μm (FIG. 3e-f), thus are clearly smaller than phase pure AA whiskers (Types VII-XI) with diameters between 3 μm and 7 μm (FIG. 3g-j), synthesized in the presence of 0.5-1.0 wt. % of 10-20 μm AA seeds.

### Effects of Morphology Modifiers

The morphology modifiers used in the present invention to yield elongated AA crystals, i.e. whiskers, are boric acid (H₃BO₃) and yttrium chloride (YCl₃). AA crystals synthesized hydrothermally in the absence of the morphology modifiers but under otherwise identical conditions, were equiaxed (FIG. 3a). Addition of 100 ppm of boron (B) in form of the boric acid resulted in the formation of a fraction of elongated AA crystals with the aspect ratio of about 2, mixed with equiaxed crystals (FIG. 3b). Further increasing the boron concentration to 0.1%, 0.5%, and 1.0% resulted in increase of the aspect ratio of the AA whiskers, reduction of their diameter, and reduction of the content of the equiaxed crystals mixed with the whiskers to practically zero at 1.0% of B. These morphological changes can be observed on the SEM pictures shown in FIG. 3(c)-(e). Addition of 0.1% of yttrium (Y) in form of the yttrium chloride resulted in the formation of AA whiskers with the aspect ratio up to 6, without any admix of equiaxed AA crystals (FIG. 3f).

In a key embodiment of the present invention, boric acid (H₃BO₃) and yttrium chloride (YCl₃) were found in this work to be efficient morphology modifiers, probably by adsorbing on crystal surfaces parallel to the c-axis, thus blocking growth in that direction. It is indicated by decreasing diameter and increasing aspect ratio of the AA crystals with increasing morphology modifier concentration. Use of these morphology modifiers was needed to synthesize AA whiskers under hydrothermal conditions.

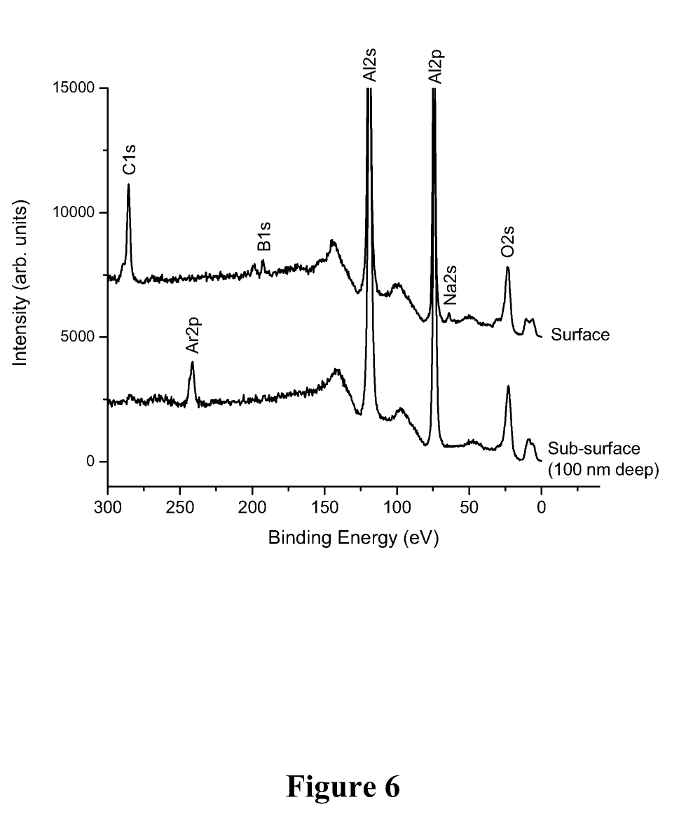

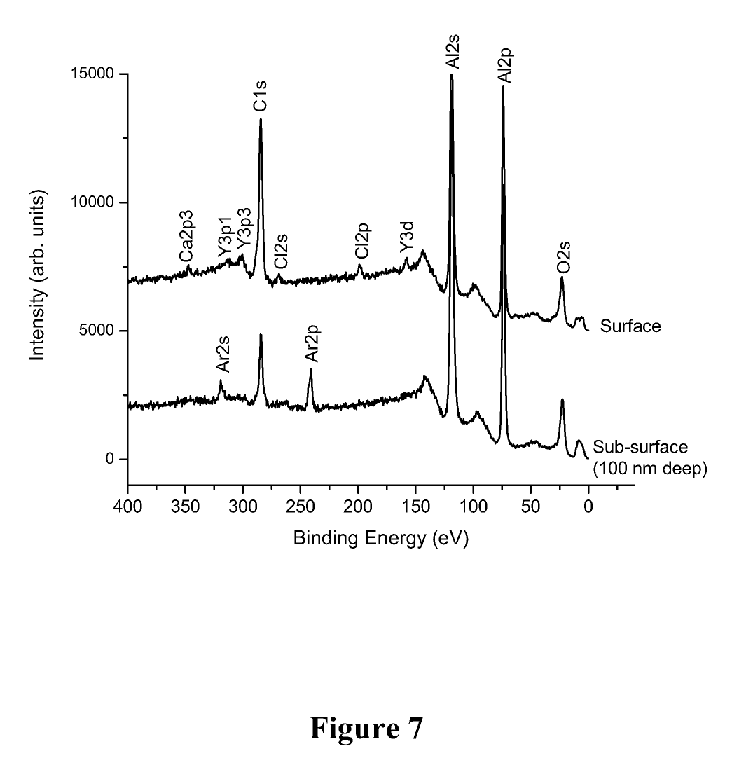

In order to validate the hypothesis of morphology modification by surface adsorption, XPS spectra were acquired on the surface and subsurface regions of selected AA whiskers. Results of the XPS analysis are summarized in FIG. 6 and FIG. 7. It is clearly seen that peaks derived from boron (FIG. 6), yttrium and chlorine (FIG. 7) are present on the surfaces of the as-synthesized whiskers, which were hydrothermally synthesized in the presence of H₃BO₃ (1.0% B) and YCl₃ (0.1% Y), respectively. These morphology modifiers are present on the whiskers surfaces despite the fact that the autoclave was vented after the hydrothermal synthesis, removing all water vapor and impurities. It is thus an indication of the existence of strong adsorption phenomena. After removing the surface layer from the AA whiskers to the depth of approximately 100 nm, XPS spectra were acquired again and no traces of Y, Cl, or B were detected (FIGS. 6-7). These results seem to confirm the adsorption mechanism hypothesis. However, other, yet unidentified effects could play a role as well.

Another argument supporting the surface adsorption mechanism is observation from the present invention that concentration of the morphology modifiers is a function of size (i.e. surface area) of the AA whiskers. The smaller the AA whiskers, the higher modifier concentration necessary to yield high aspect ratio whiskers. Thus with increasing surface area of the synthesized AA whiskers, higher concentration of the modifiers are necessary. Conversely, content of the boric acid modifier decreases from 1.0 wt. % to 0.3 wt % for lower surface area, i.e. high diameter, and larger AA whiskers (Types VII-X). Use of 0.5-1.0 wt % of boric acid during synthesis of the large AA whiskers (Types VII-X1) resulted in complete blockage of the growth and no or limited AA crystallization.

The adsorbed species on the surfaces of the AA whiskers could be removed, if necessary, by treatments using either acids or bases, or their combinations, or even by thermal treatments. Such treatments could also result in etching of the whiskers surface, thus increasing their roughness, which may be desirable in certain applications, for example in catalytic applications by better nesting particles of the catalysts. More specifically, AA is generally insoluble in acids and bases whereas yttrium and yttria are soluble in acid and have little solubility in bases. Thus the external Y from the AA whiskers could be removed via an acid extraction. It can also be combined with a base treatment first, to erode the AA around Y followed by an acid extraction that will remove both Y and Al from the external surface. Nitric acid should be the choice to eliminate any contamination with chloride that bind strongly to aluminum oxides. Borates are soluble in bases thus can be easily removed by caustic extraction. Any alkali left in the solid can be removed by acid wash with nitric acid after the alkaline extraction.

### Porous AA Ceramics Synthesized Hydrothermally

In another key embodiment of the present invention, the AA whiskers synthesized hydrothermally, can form strong porous ceramic skeleton. Formation of such porous AA ceramics is due to a combination of whiskers interlocking and hydrothermal sintering (mass transport by dissolution-precipitation), which results in the formation of strong connections (necks) between the whiskers during the hydrothermal synthesis. Typical properties of the porous AA ceramics are summarized in Table III.

TABLE III
Typical physicochemical properties of porous AA ceramics synthesized
by the hydrothermal method

| Type of | | Porosity (%); | | | |
|---|---|---|---|---|---|
| the | Used | (Median | BET | Total | Average |
| Porous | Morphology | Pore | Surface | Pore | Crush |
| AA | Modifiers | Diameter | Area | Volume | Strength |
| Ceramics | (Concentration) | (μm)) | (m²/g) | (cm³/g)* | (MPa) |
| Type A | H₃BO₃ | 67.0% | 1.27 | 0.51/0.65 | 2.9 |
| | (1.0% B) | (4 μm) | | | |
| Type B | H₃BO₃ | 67.5% | 1.06 | 0.52/0.90 | 1.0 |
| | (0.5% B) | (4 μm) | | | |
| Type C | YCl₃ | 63.7% | 1.51 | 0.44/0.81 | 0.9 |
| | (0.1% Y) | (1 μm/6 μm) | | | |

First number as-measured by water absorption; second number as-measured by mercury

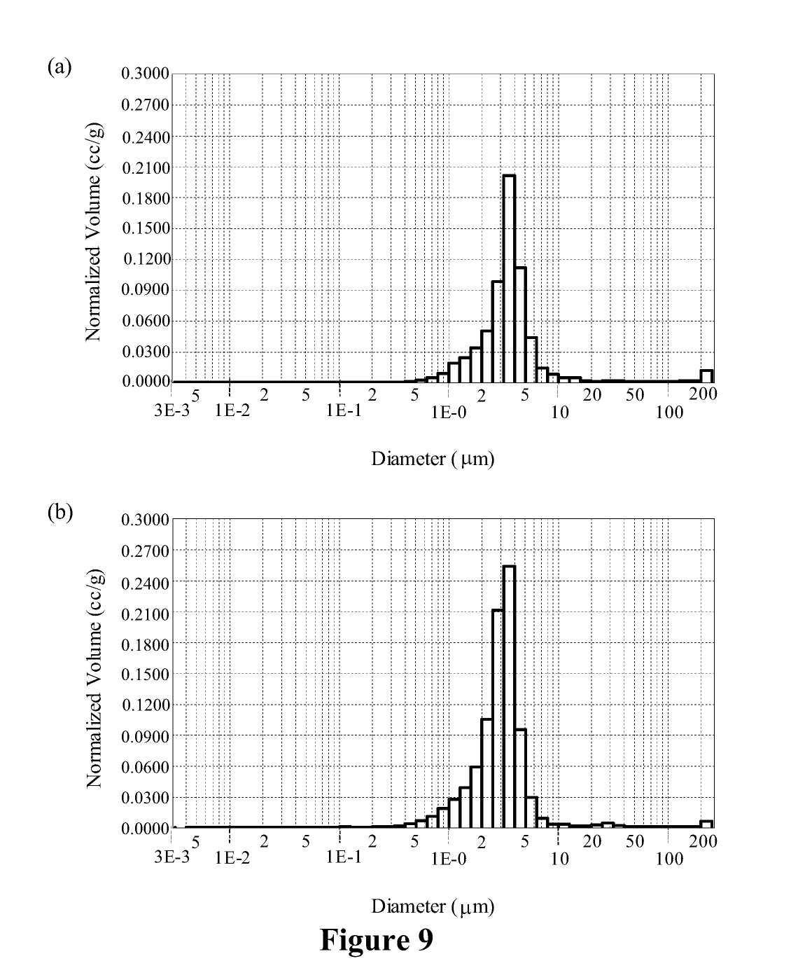

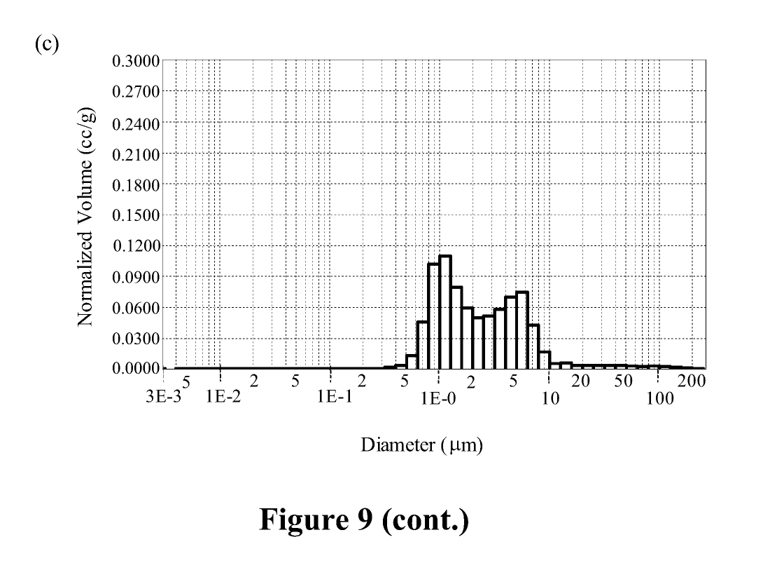

The porosities of the porous AA ceramic ranged from 63.7% to 67.5%, pore volumes between 0.51 and 0.90 cm³/g, median pore diameters varied between 1 μm and 6 μm, BET surface areas were 1.06-1.51 m²/g, and the compressive strength ranged between 0.9 and 2.9 MPa (see Table III for details). The pore size distributions were either single- or bi-modal, with the vast majority of pores being between 0.5 μm and 50 μm (FIG. 9). Such combination of properties does not differ considerably from AA supports obtained by compaction or extruding, followed by sintering, except for the strength. Although the high-temperature sintered AA supports exhibit considerably higher strengths, some of the lowest numbers obtained are around 5 MPa, which is actually very close to the values obtained for porous AA ceramics synthesized hydrothermally.

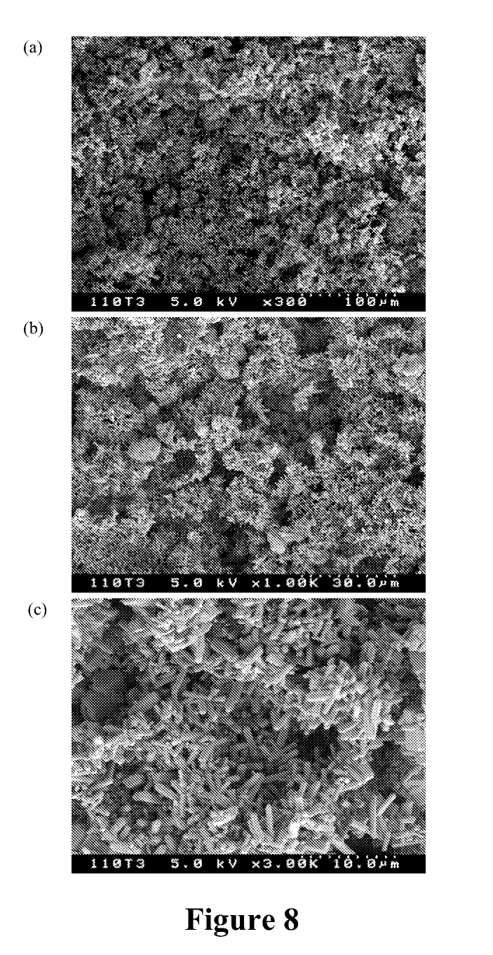

The SEM analysis confirmed very high uniformity of microstructure of the porous AA ceramics synthesized hydrothermally. Very uniform whisker sizes and pore size distributions were observed in all cases (see FIG. 8 as representative example). The SEM-based microstructural observations were in a very good agreement with pore size distribution data in all cases. The whiskers were randomly oriented in all cases, thus no texturing was observed. In some cases, admix of equiaxed particles, mixed with the whiskers was observed.

Excellent combination of strength, porosity and surface area were obtained for Type A porous AA ceramics: 67% porosity, 0.51-0.65 cm³/g total pore volume, 1.27 m²/g BET surface area, and 2.9 MPa average crush strength.

The porous AA ceramics of the present invention (see Examples 12-14) are well suited for a variety of demanding applications, such as refractory thermal insulations, membranes, filters for molten metals and hot gases, catalytic supports in chemical processing, lightweight structural components, etc.

In addition to the hydrothermal synthesis of pure porous AA ceramics, consisting of the AA whiskers, other AA-based ceramics could be prepared by the hydrothermal method. They include but are not limited to the following materials: various types of AA whiskers/boehmite porous ceramics with a wide range of AA/boehmite ratio (0-100%), AA whiskers mixtures with various sizes and volume fractions of equiaxed AA crystallites, AA whiskers-based ceramics mixed with a variety of additives, such as Cs salts, TiO₂, ZrO₂, SiO₂, Mg Silicate, CaSilicate, etc., which can be used in order to enhance properties of the AA ceramics.

### Porous AA Ceramics Prepared By Extruding and Sintering

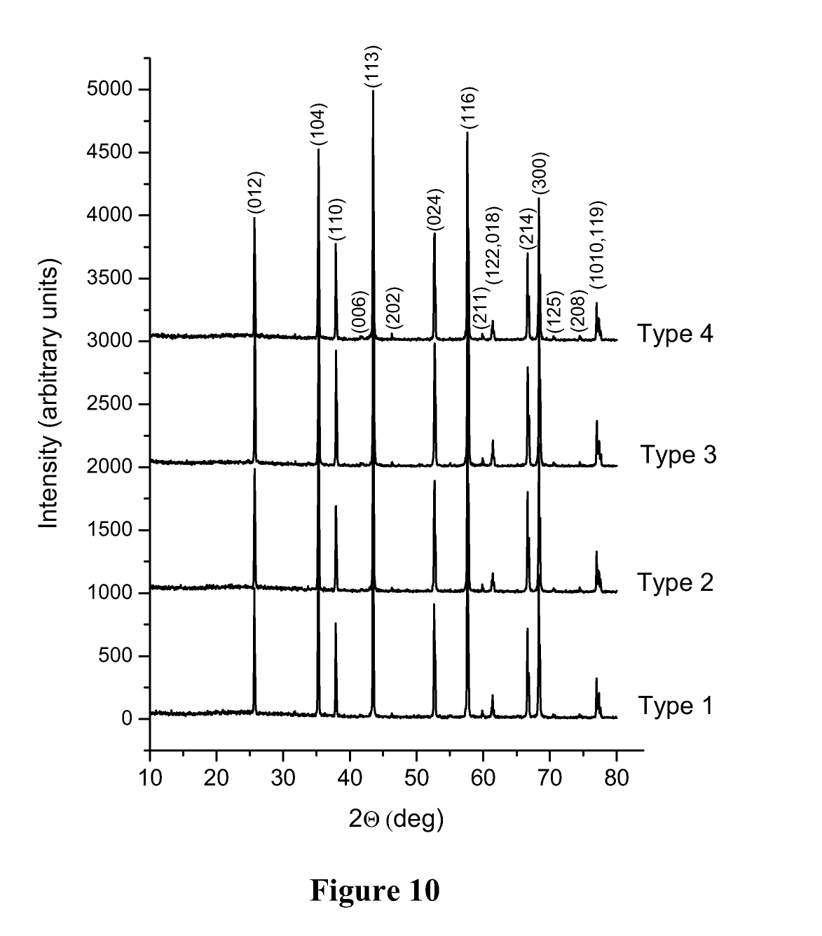

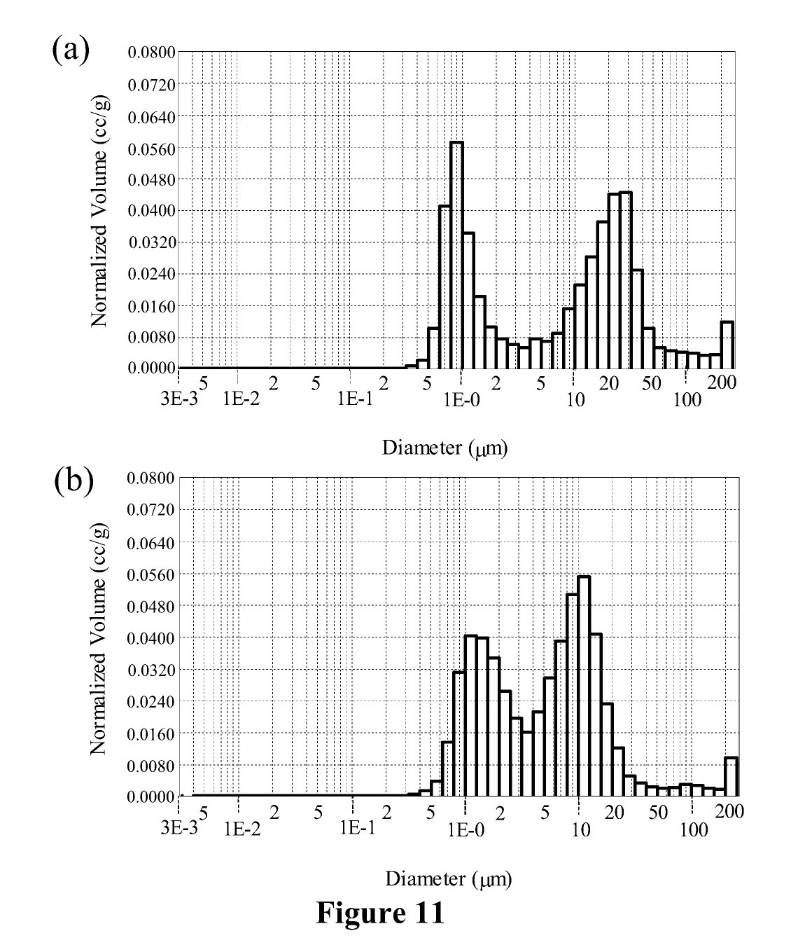

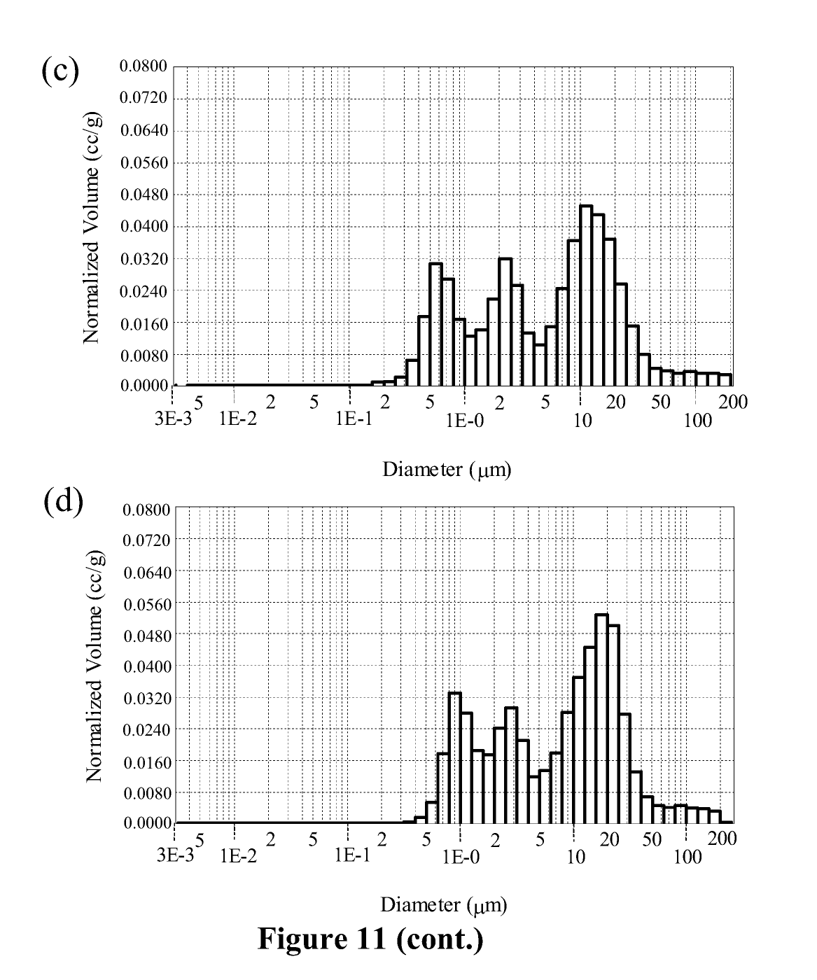

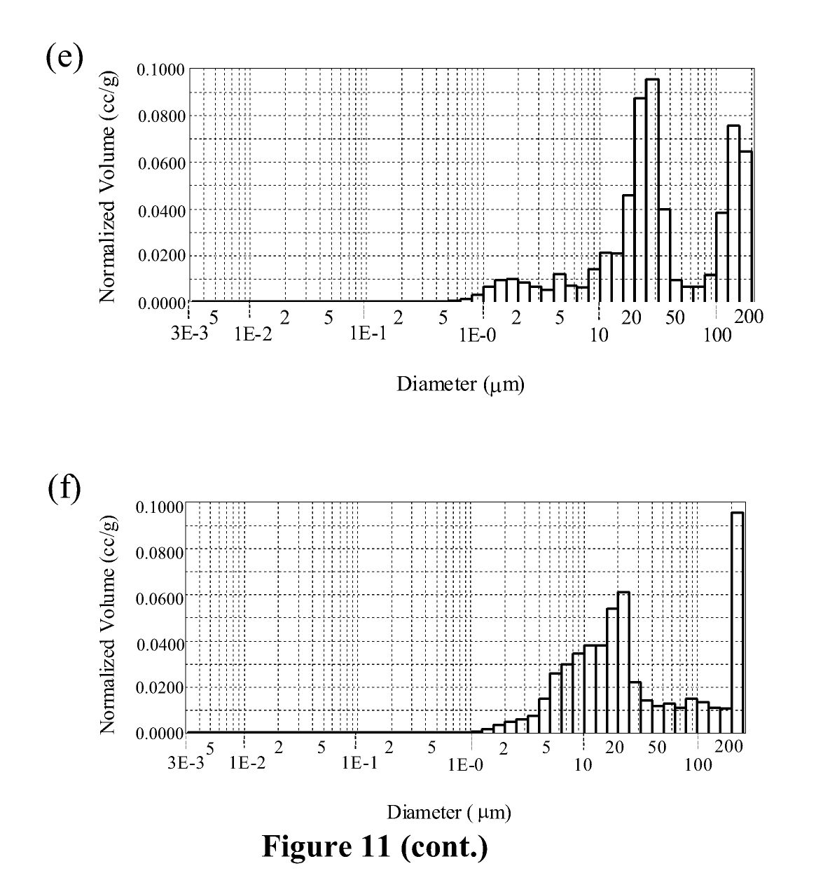

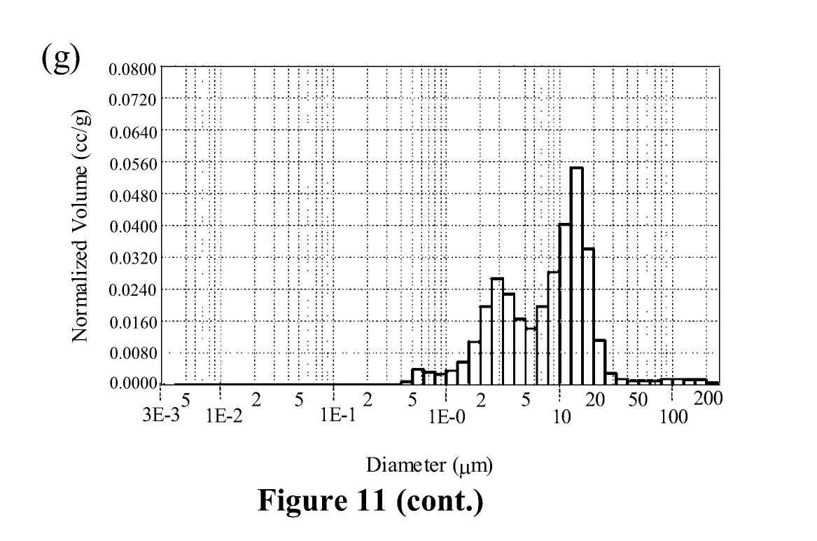

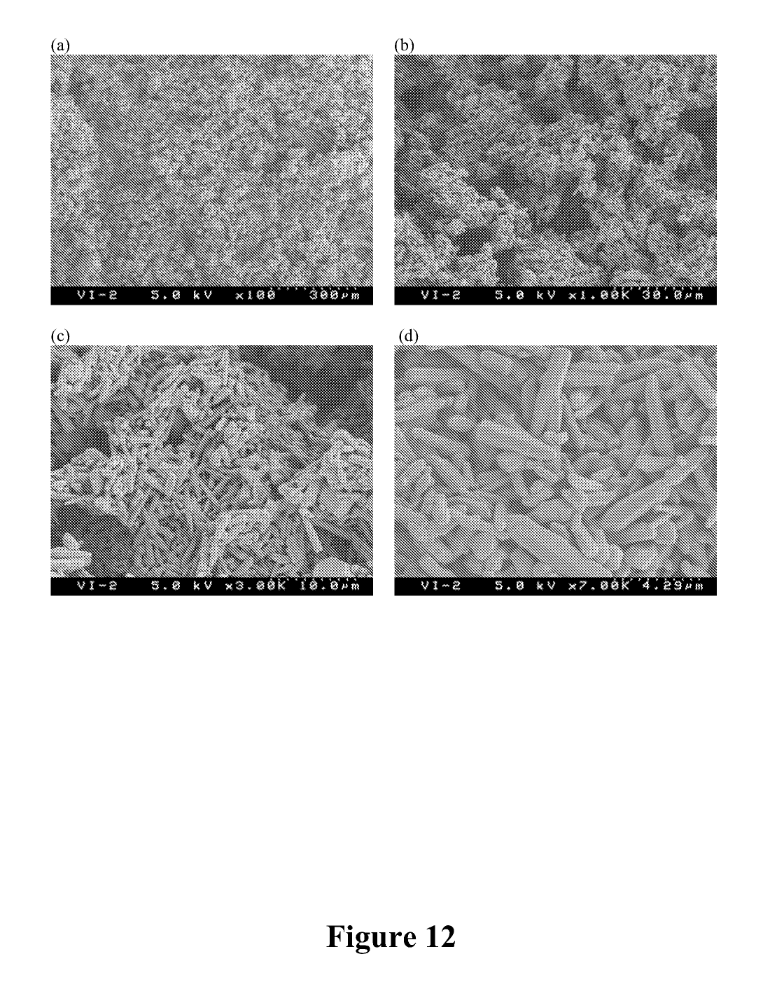

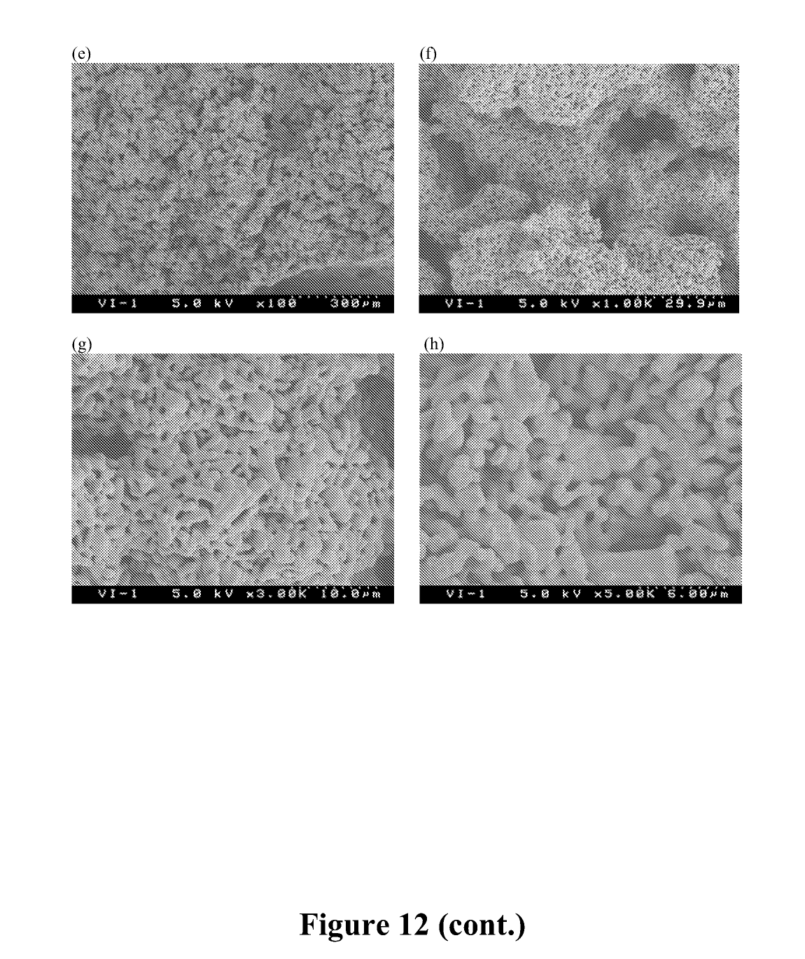

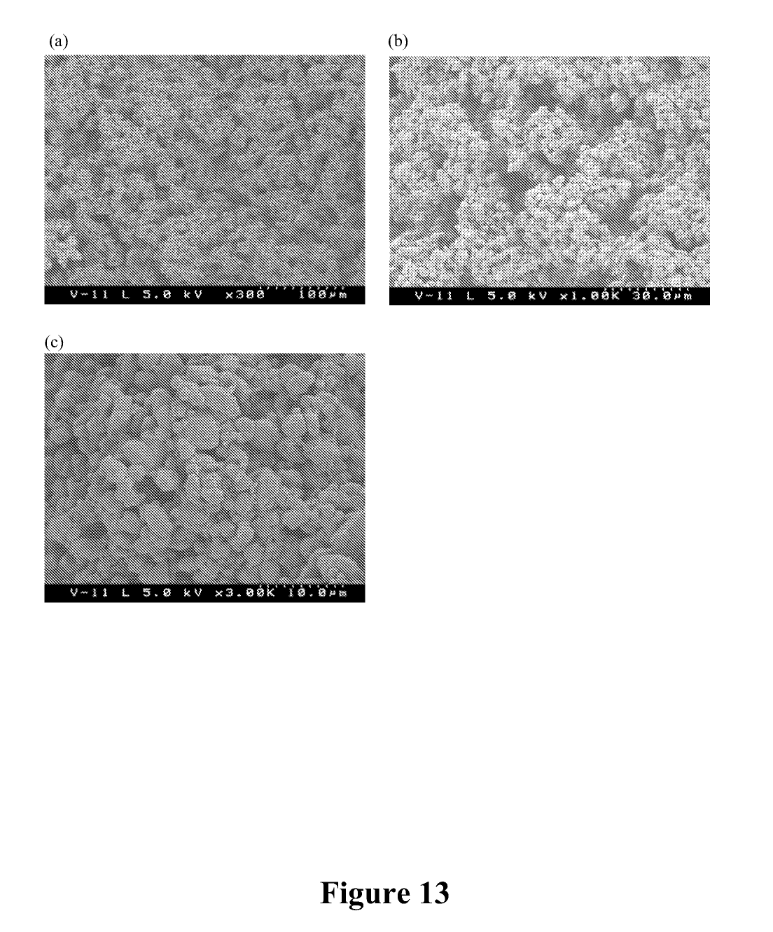

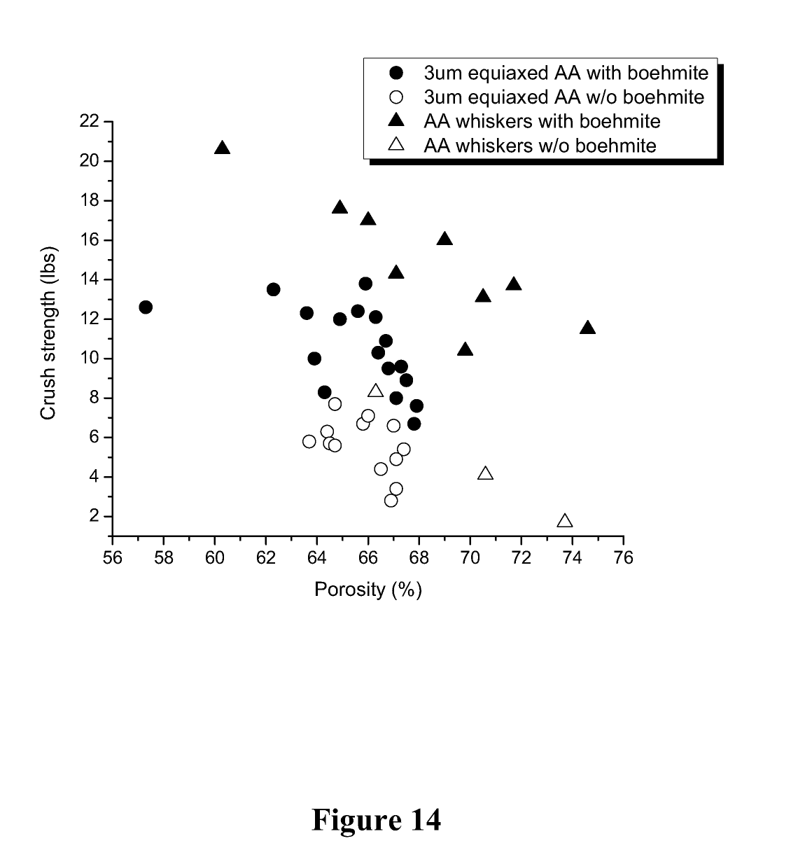

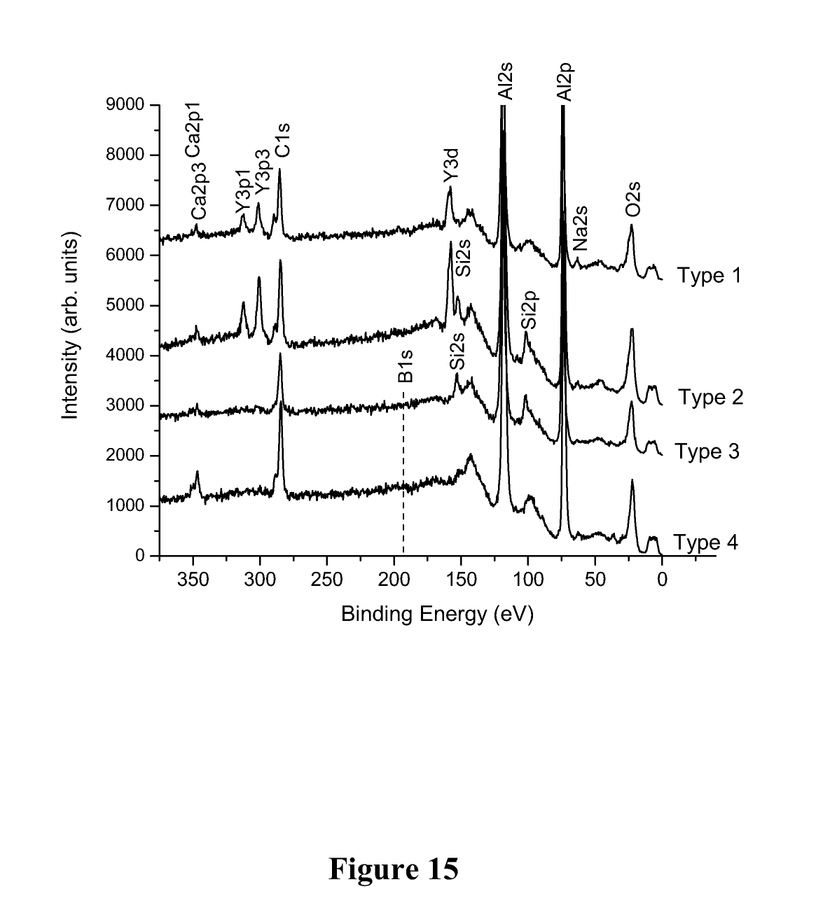

Several compositions of porous AA ceramics were fabricated by extruding followed by sintering using hydrothermally synthesized AA whiskers of this invention as starting materials (Examples 15-20). Porosities, pore volumes, pore size distributions, and BET surface areas of several different porous AA ceramics, sintered under different conditions, are summarized in Table IV and in FIG. 11. Their mechanical properties are revealed in Table IV and FIG. 14. Phase and chemical compositions of the porous AA ceramics are summarized in Table V and in FIGS. 10 and 15. Microstructures of the porous AA ceramics are shown in FIGS. 12-13. Based upon the analysis of all these data, several effects were observed. They are being discussed in the following sections.

TABLE IV
Properties of porous AA ceramics made from hydrothermally synthesized AA
whiskers with or without equiaxed AA powders, formed by extruding, and sintered in air
at 1,350-1,500° C. (6-24 hrs)

| | | | BET | | |
|---|---|---|---|---|---|
| | | | Surface | | |
| | | | Area | | |
| | | | (m²/g) | | Average |
| | | | (micro- | Total | (minimum) |
| Composition of | | Porosity (%); | pore | Pore | Crush |
| porous AA | Sintering | (Median Pore | surface | Volume | Strength |
| ceramics* | Conditions | Diameter (μm)) | area (m²/g))** | (cm³/g)*** | (pounds) |
| Type 1: AA | 1,350° C. | 70.5% | 1.03 | 0.60/ | 13.1 |
| whiskers (Type VI, | (24 hrs) | (0.8 μm/25 μm/200 μm) | (0.42) | 0.56 | (11.2) |
| as-synth.) + | 1,450° C. | 66.0% | 0.68 | 0.49/ | 17.0 |
| 27.9% W + | (8 hrs) | (0.9 μm/30 μm/200 μm) | (0.55) | 0.48 | (14.2) |
| 10.1% B + 0.6% N + | 1,500° C. | 60.3% | 0.67 | 0.38/ | 20.6 |
| 25.7% V | (6 hrs) | (0.9 μm/30 μm/200 μm) | (—) | 0.40 | (16.7) |
| Type 2: AA | 1,350° C. | 73.7% | — | 0.70/ | 1.7 |
| whiskers (Type VI, | (24 hrs) | (0.8 μm/10 μm/150 μm | | 0.69 | (1.0) |
| as-synth.) + | 1,450° C. | 70.6% | 1.19 | 0.60/ | 4.1 |
| 32.0% W + 0.0% B + | (8 hrs) | (1.5 μm/10 μm/150 μm) | (0.13) | 0.53 | (3.5) |
| 0.0% N + 29.5% V + | 1,500° C. | 66.3% | 0.73 | 0.49/ | 8.3 |
| 0.1% S + 0.1% A | (6 hrs) | (0.9 μm/10 μm/200 μm) | (0.11) | 0.46 | (6.4) |
| Type 3: AA | 1,350° C. | 74.6% | 0.97 | 0.73/ | 11.5 |
| whiskers (Type V, | (24 hrs) | (0.5 μm/2 μm/15 μm/ | (0.09) | 0.54 | (10.0) |
| as-synth.) + | | 100 μm) | | | |
| 25.7% W + 9.3% B + | 1,450° C. | 69.0% | 0.9-1.1 | 0.56/ | 16.0 |
| 0.6% N + | (8 hrs) | (0.5 μm/2 μm/15 μm/ | (0.20) | 0.50 | (13.9) |
| 23.7% V + 0.1% S + | | 100 μm) | | | |
| 0.1% A | 1,500° C. | 67.1% | 0.73 | 0.51/ | 14.3 |
| | (6 hrs) | (1.0 μm/3 μm/15 μm/ | (0.66) | 0.45 | (12.2) |
| | | 70 μm) | | | |
| Type 4: AA | 1,350° C. | 69.8% | 0.78 | 0.58/ | 10.4 |
| whiskers (Type IV, | (24 hrs) | (0.9 μm/3 μm/20 μm/ | (0.31) | 0.56 | (9.0) |
| as-synth.) + | | 100 μm) | | | |
| 29.2% W + | 1,450° C. | 71.7% | 0.67 | 0.63/ | 13.7 |
| 10.6% B + 0.6% N + | (8 hrs) | (0.9 μm/3 μm/20 μm/ | (0.36) | 0.52 | (12.0) |
| 26.9% V | | 100 μm) | | | |
| | 1,500° C. | 64.9% | 0.59 | 0.46/ | 17.6 |
| | (6 hrs) | (0.9 μm/3 μm/15 μm/ | (0.30) | 0.43 | (15.8) |
| | | 200 μm) | | | |
| Type 5: AA | 1,400° C. | 68.2% | — | 0.54 | 7.5 |
| whiskers (Type | (24 hrs) | (—) | | | (7.0) |
| VIII, as-synth) | 1,450° C. | 68.6% | — | 0.55 | 8.4 |
| mixed with 340 ppm | (8 hrs) | (—) | | | (7.7) |
| Si-doped AA | 1,500° C. | 67.8% | — | 0.53 | 8.6 |
| powder | (6 hrs) | (—) | | | (7.3) |
| (proportions | | | | | |
| 50/50) + 28.8% W + | | | | | |
| 10.5% B + | | | | | |
| 0.6% N + 26.6% V | | | | | |
| Type 6: AA | 1,400° C. | 68.2% | 0.89 | 0.54/ | 11.0 |
| whiskers (Type | (24 hrs) | (2 μm/30 μm/150 μm) | | 0.57 | (10.2) |
| VIII, as-synth) | 1,450° C. | 68.2% | 0.71 | 0.54 | 12.0 |
| mixed with 780 ppm | (8 hrs) | (2 μm/30 μm/200 μm) | | | (10.7) |
| Si-doped | 1,500° C. | 67.6% | — | 0.52 | 13.0 |
| AA powder | (6 hrs) | (—) | | | (10.5) |
| (proportions | | | | | |
| 30/70) + | | | | | |
| 28.8% W + | | | | | |
| 10.5% B + | | | | | |
| 0.6% N + 26.6% V | | | | | |
| Type 7: AA | 1,400° C. | 69.3% | — | 0.57 | 8.9 |
| whiskers (Type | (24 hrs) | (—) | | | (8.0) |
| VIII, as-synth) | 1,450° C. | 69.2% | 0.55 | 0.56 | 10.5 |
| mixed with 780 ppm | (8 hrs) | (10-20 μm/200 μm) | | | (9.7) |
| Si-doped AA | 1,500° C. | 68.2% | — | 0.54 | 11.0 |
| powder | (6 hrs) | (—) | | | (10.1) |
| (proportions | | | | | |
| 70/30) + 28.8% W + | | | | | |
| 10.5% B + | | | | | |
| 0.6% N + 26.6% V | | | | | |
| V-11: 3 μm AA | 1,400° C. | 66.8% | — | 0.50 | 9.5 |
| equiaxed powders | (12 hrs) | (—) | | | (8.9) |
| (as-synth.) + | 1,400° C. | 66.4% | 0.7 | 0.50 | 10.3 |
| 25.7% W + 9.3% B + | (24 hrs) | (3 μm/14 μm) | (—) | | (9.3) |
| 0.5% N + 23.7% V | 1,450° C. | 65.6% | 0.67 | 0.48 | 12.4 |
| Comparative | (8 hrs) | (3 μm/14 μm) | (0.22) | | (11.7) |
| example, as- | | | | | |
| disclosed in | | | | | |
| (US 2007/028087) | | | | | |

*W denotes de-ionized H₂O, B denotes nano-sized boehmite, N denotes 70% HNO₃, V denotes petroleum jelly, S denotes 40% colloidal dispersion of 20 nm SiO₂ in water, A denotes 25% NH₄OH. All concentrations are in weight % calculated with respect to the total AA mass in the starting extruding paste.
**The number without brackets corresponds to the total BET surface area, while the number in square brackets corresponds to the surface area derived from micro-pores only.
***First number as-measured by water absorption; second number was measured by mercury intrusion porosimetry.

TABLE V
Phase and chemical purifies of porous AA ceramics made from
hydrothermally synthesized AA whiskers, sintered in air at
1,450° C. (8 hrs)

| Property | Type 1 | Type 2 | Type 3 | Type 4 | Type 6 |
|---|---|---|---|---|---|
| Phase purity | 100%- | 100%- | 100%- | 100%- | 100%- |
| | Al₂O₃ | Al₂O₃ | Al₂O₃ | Al₂O₃ | Al₂O₃ |
| Chemical | >99.8 | >99.8 | >99.9 | >99.9 | >99.9 |
| purity (%) | | | | | |
| Impurities Si | — | 90 ppm | 70 ppm | <10 ppm | 380 ppm |
| Na | — | 10 ppm | <10 ppm | <10 ppm | 120 ppm |
| Fe | — | 120 ppm | 170 ppm | 140 ppm | 100 ppm |
| Mg | — | 10 ppm | 10 ppm | 20 ppm | <10 ppm |
| Ca | — | 30 ppm | 30 ppm | 40 ppm | 40 ppm |
| B | — | <10 ppm | 30 ppm | 70 ppm | 40 ppm |
| Y | — | 750 ppm | — | — | — |

Effects of the AA Whiskers vs. AA Equiaxed Crystals as Starting Materials for Porous AA Ceramics

The porosities, pore volumes, and strength of the porous AA supports can be significantly and simultaneously increased by the use of AA whiskers, instead of the AA equiaxed particles, as starting materials in making porous AA ceramics. As revealed in Table IV, porosities and pore volumes of porous AA ceramics made from the AA whiskers are in most cases in excess of 66% (up to 75%) and 0.50 cm³/g (up to 0.70 cm³/g), respectively, as compared to the porous AA ceramics made from equiaxed AA powders (about 66% and 0.48-0.50 cm³/g, respectively). At the same time, the crush strength of the porous AA ceramics made from the AA whiskers is significantly higher than the crush strength of the porous AA ceramics made from equiaxed AA powders. It is difficult to make a direct comparison between particular samples, as the strength is a strong function of porosity. Therefore, this relationship is demonstrated in a graphical form in FIG. 14, where strength of many porous AA ceramics is plotted as a function of porosity. Clearly, the samples made from the AA whiskers exhibited much higher strength in the entire range of porosities.

BET surface areas of the porous AA ceramics from the AA whiskers are in the range of 0.6-1.2 m²/g, which in most cases is higher than the 0.7 m²/g for the ceramics made from equiaxed AA powders.

The SEM analysis confirmed the uniformity of the microstructures of the porous AA ceramics, i.e. very uniform grain size and multi-modal pore size distributions in all cases (see pictures in FIG. 12 as representative examples). The SEM revealed also that the microstructure of the ceramics made from the AA whiskers consists of elongated grains in all cases. In the Type 2 and Type 3 porous AA ceramics, the AA whiskers are clearly visible, and they do not appear to significantly change during sintering (FIG. 12d). In the Type 4 porous AA ceramics, the whiskers morphology has changed during sintering, but they could still be seen. The changes are, primarily, thickening of the necks between individual crystallites and rounding of sharp crystallite edges and corners, due to the sintering of AA whiskers and equiaxed AA powders mix possibly with some liquid phase sintering effects. Only the Type 1 porous AA ceramics do not reveal the presence of the AA whiskers; instead a mixture of elongated and equiaxed grains is observed (FIG. 12h). The microstructure of Type 1 porous AA ceramics shows typical grain accommodations, which is characteristic to liquid phase sintering. Thus the microstructures of the porous AA ceramics can be controlled over a wide range by the Type of the AA whiskers and other processing conditions.

As shown in FIG. 11, the pore size distributions are multi-modal in the case of the ceramics made from the AA whiskers, with modes around 0.8-1.5 μm, 2-3 μm, 10-30 and 70-200 μm. Conversely, pore size distributions in the porous AA ceramics made from equiaxed AA powders, are bi-modal, with modes located around 3 μm and 14 μm. Clearly, the use of various AA whiskers can be allowed to control the pore size distributions in a very wide range. Use of large-diameter AA whiskers resulted in ceramics with almost no pores smaller than 1 μm (FIG. 11e-f).

The combination of the properties described above in addition to high phase purity (100% of the α-Al₂O₃ phase in all cases) and high chemical purity (>99.8-99.9%) shown in Table V and FIG. 10, is favorable for a variety of applications of the porous AA ceramics made from the AA whiskers. It is particularly favorable for applications as catalytic supports.

Effects of Dopants and/or Sintering Additives

Chemical properties of the AA whiskers and the porous AA ceramics made from the AA whiskers are summarized in Table II and Table V, respectively. It is apparent that the Type IV and Type V whiskers contain 550-730 ppm of boron (B), while the Type VI whiskers contain 950 ppm of yttrium (Y). After the ceramic fabrication and sintering, the yttrium content remained practically unchanged (Type 1 and Type 2 porous AA ceramics), while the content of boron was reduced by two orders of magnitude (Type 3-6 porous AA ceramics). Results of the chemical analysis were confirmed by the XPS analysis, which confirmed the presence of yttrium in Type 1-2 porous AA ceramics and no detectable levels of boron in Type 3-4 porous AA ceramics (FIG. 15). There is no indication that the high Y or B contents in the AA whiskers alone are in any respect responsible for the micro-structural changes and/or liquid phase sintering.

Another dopant/sintering additive, which was added during the fabrication process, is silica. It is present in Type 2 and Type 3 porous AA ceramics in quantities below 100 ppm of Si and in concentration of 380 ppm Si in Type 6 porous AA ceramics (Table V). Presence of silicon was detected by XPS analysis as well (FIG. 15). The addition of the colloidal silica or using Si as a dopant in AA appears to significantly reduce the content of micro-pores. As shown in Table IV, the BET surface area derived from the micro-pores was only 0.09-0.20 m²/g in the case of most materials containing silica, while it was on the level of 0.30-0.55 m²/g in the other samples. Moreover, there were almost no micro-pores in Type 6-7 ceramics (FIG. 11e-f). Micro-pore size distributions for porous AA ceramics Types 1-4, did not exhibit significant differences.

The use of Type IV and Type V AA whiskers results in the formation of chemically very pure porous AA ceramics, while the use of Type VI whiskers results in Y-doped samples. However, the presence of yttrium can be advantageous in certain applications.

### Effects of Boehmite Additions

The addition of nano-sized boehmite as a binder to the extruding compositions results in a strength increase from 1-8 lbs to 10-21 lbs for porous AA ceramics made from the AA whiskers and from about 3-8 lbs to 7-14 lbs level for porous AA ceramics made from equiaxed AA (see data in FIG. 14). However, it is important to disperse the boehmite uniformly in-between the AA crystallites, for instance with nitric acid, in order to obtain such strength increase. Well-dispersed boehmite (already transformed to AA) may or may not be visible after sintering as small particles filling spaces between large AA grains (see FIGS. 12-13).

Interactions of the nano-sized boehmite particles, which contain some impurities, with yttrium present in the AA whiskers (Type VI), could have resulted in strong liquid phase sintering. Conversely, the presence of silica alone did not result in any clearly pronounced liquid phase sintering effects (FIG. 12).

### Effects of the Sintering Conditions

Irrespectively of the composition of the porous AA ceramics, increasing the sintering time and/or increasing the sintering temperature in the investigated range of 1,350-1,500° C. (6-24 hrs), results in significant increase of strength accompanied by reductions of porosity, pore volume, and specific surface area. Pore size distribution changes are not dramatic, and are more strongly pronounced in Type 1 and Type 2 porous AA ceramics. With increasing sintering temperature, relative contribution of micro-pores to the BET surface area increases, as shown in Table IV. Micro-pore size distributions may change as well, with distribution shown in FIG. 11a being typical for very high micro-pores-derived BET surface area, such as Type 1 porous AA ceramics sintered at 1,450° C. (8 hours) or Type 3 porous AA ceramics sintered at 1,500° C. (6 hours). Thus the mechanical properties and micro-structural features of the porous AA ceramics can be controlled in a wide range by sintering conditions.

Other Porous AA Ceramics from Hydrothermally Synthesized AA Whiskers

In addition to using various types of AA whiskers or AA whiskers/equiaxed AA mixtures, other compositions can be used as well. For example, combination of hydrothermally synthesized boehmite with AA whiskers or AA whiskers/equiaxed AA mixtures, AA whiskers mixtures with various sizes of equiaxed AA crystallites, sintering additives, such as Cs salts, TiO₂, ZrO₂, SiO₂, Mg Silicate, CaSilicate, etc. can be used in order to enhance formation of porous AA ceramics, which can be used for a variety of applications.

### SPECIFIC EXAMPLES

### Example 1

### Hydrothermal Synthesis of Type V AA Whiskers Using H₃BO₃ (1.0% B) Morphology Modifier

Hydrothermal synthesis of 16.3 lbs of AA whiskers was performed as follows:

One titanium container (12″ Diameter×11″ Height) was cleaned and 12.5 lbs of DI water was added to it. Then, 281 g of 30% H₂O₂ aqueous solution was added to the container and its content was stirred. Then, 88.79 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″ Dia×120″H) together with 9 other containers with loads targeting different types of AA whiskers or powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 0.5-2.0 μm, 2-6 μm, and 4-7, respectively. No equiaxed crystals were observed. SEM and XRD confirmed crystal size and phase purity of the AA whiskers. Morphology of the as-synthesized AA whiskers is shown in FIG. 3e. After discarding contaminated areas in each container (¼″ from the top layer and ¼″ near the liner walls and bottom), approximately 14 lbs of as-synthesized AA whiskers was retrieved. Chemical analysis of the as-synthesized powder gave the following level of impurities: Na=200 ppm, Si=30 ppm, Fe=50 ppm, Ca=30 ppm, Mg<10 ppm, B=730 ppm (Table II). Specific surface area of the synthesized AA whiskers as measured by nitrogen adsorption using BET isotherm was 1.39 m²/g (Table II).

### Example 2

### Hydrothermal Synthesis of Type IV AA Whiskers Using H₃BO₃ (0.5% B) Morphology Modifier

Hydrothermal synthesis of 16.3 lbs of AA whiskers was performed as follows:

One titanium container (12″ Dia×11″ H) was cleaned and 12.5 lbs of DI water was added to it. Then, 281 g of 30% H₂O₂ aqueous solution was added to the container and its content was stirred. Then, 44.35 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″ Dia×120″ H) together with 9 other containers with loads targeting different types of AA whiskers or powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 0.5-2.0 μm, 1-10 μm, and 2-12, respectively. A small fraction of aggregated equiaxed AA crystals (0.3-1.0 μm in diameter) was found mixed with the whiskers. SEM and XRD confirmed crystal size and phase purity of the AA whiskers. Morphology of the as-synthesized AA whiskers is shown in FIG. 3d. After discarding contaminated areas in each container (¼″ from the top layer and ¼″ near the liner walls and bottom), approximately 14 lbs of as-synthesized AA whiskers was retrieved. Chemical analysis of the as-synthesized powder gave the following level of impurities: Na=170 ppm, Si=20 ppm, Fe=50 ppm, Ca=30 ppm, Mg<10 ppm, B=550 ppm (Table II). Specific surface area of the synthesized AA whiskers as measured by nitrogen adsorption using BET isotherm was 1.14 m²/g (Table II).

### Example 3

### Hydrothermal Synthesis of Type III AA Whiskers Using H₃BO₃ (0.1% B) Morphology Modifier

Hydrothermal synthesis of 16.3 lbs of AA whiskers was performed as follows:

One titanium container (12″ Dia×11″ H) was cleaned and 12.5 lbs of DI water was added to it. Then, 281 g of 30% H₂O₂ aqueous solution was added to the container and its content was stirred. Then, 8.870 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″ Dia×120″ H) together with 9 other containers with loads targeting different types of AA whiskers or powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 3-5 μm, 6-15 μm, and 2-4, respectively. A large fraction of aggregated equiaxed AA crystals (1-2 μm in diameter) was found mixed with the whiskers. SEM and XRD confirmed crystal size and phase purity of the AA whiskers. Morphology of the as-synthesized AA whiskers is shown in FIG. 3c. After discarding contaminated areas in each container (¼″ from the top layer and ¼″ near the liner walls and bottom), approximately 14 lbs of as-synthesized AA whiskers was retrieved. Chemical analysis of the as-synthesized powder gave the following level of impurities: Na=170 ppm, Si=30 ppm, Fe=50 ppm, Ca=50 ppm, Mg<10 ppm, B=170 ppm (Table II). Specific surface area of the synthesized AA whiskers as measured by nitrogen adsorption using BET isotherm was 0.56 m²/g (Table II).

### Example 4

### Hydrothermal Synthesis of Type I AA Whiskers Using H₃BO₃ (0.01% B) Morphology Modifier

Hydrothermal synthesis of 16.3 lbs of AA whiskers was performed as follows: One titanium container (12″ Dia×11″ H) was cleaned and 12.5 lbs of DI water was added to it. Then, 281 g of 30% H₂O₂ aqueous solution was added to the container and its content was stirred. Then, 0.887 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″Dia×120″H) together with 9 other containers with loads targeting different types of AA whiskers or powders. 3.9 L of DI water were placed in the bottom of the autoclave. Total water content in the autoclave, including water from precursor decomposition was 98.9 L., which is 38% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 4.5 days, with temperature stability of a few ° C., with pressure about 2,000-2,250 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. After completing the heating cycle, the autoclave was cooled in an uncontrolled fashion. After unloading the autoclave, the powders were dried in a convection oven at 260° C. for 48 hours. The synthesized powder was inspected by optical microscope and it was found that it consisted of a mixture of equiaxed AA crystals (1-3 μm in diameter) and elongated AA crystals, with approximate diameters, length, and aspect ratios of 5 μm, 10 μm, and 2, respectively. SEM and XRD confirmed crystal size and phase purity of the AA whiskers. Morphology of the as-synthesized AA whiskers is shown in FIG. 3b. After discarding contaminated areas in each container (¼″ from the top layer and ¼″ near the liner walls and bottom), approximately 14 lbs of as-synthesized AA whiskers was retrieved. Chemical analysis of the as-synthesized powder gave the following level of impurities: Na=40 ppm, Si=<50 ppm, Fe=40 ppm, Ca=50 ppm, Mg<10 ppm, B<10 ppm (Table II).

### Example 5

### Hydrothermal Synthesis of Type VI AA Whiskers Using YCl₃ (0.1% Y) Morphology Modifier

Hydrothermal synthesis of 16.3 lbs of AA whiskers was performed as follows: One titanium container (12″Dia×11″H) was cleaned and 12.5 lbs of DI water was added to it. Then, 281 g of 30% H₂O₂ aqueous solution was added to the container and its content was stirred. Then, 28.06 g of yttrium chloride hydrate (YCl₃.xH₂O, ACS grade, 99.9%) as morphology modifier was added to the container and its content was stirred in order to completely dissolve the yttrium chloride powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 0.3-1.0 μm, 2-6 μm, and 4-10, respectively. No equiaxed crystals were observed. SEM and XRD confirmed crystal size and phase purity of the AA whiskers. Morphology of the as-synthesized AA whiskers is shown in FIG. 3f. After discarding contaminated areas in each container (¼″ from the top layer and ¼″ near the liner walls and bottom), approximately 14 lbs of as-synthesized AA whiskers was retrieved. Chemical analysis of the as-synthesized powder gave the following level of impurities: Na=110 ppm, Si=10 ppm, Fe=50 ppm, Ca=30 ppm, Mg<10 ppm, B=40 ppm, Y=730 ppm (Table II). Specific surface area of the synthesized AA whiskers as measured by nitrogen adsorption using BET isotherm was 1.36 m²/g (Table II).

### Example 6

### Hydrothermal Synthesis of Type VII AA Whiskers Using H₃BO₃ (0.1% B) Morphology Modifier

Hydrothermal synthesis of 20 lbs of AA whiskers was performed as follows: One titanium container (12″Dia×11″H) was cleaned and 15.0 lbs of DI water was added to it. Then, 337 g of 30% H₂O₂ aqueous solution was added to the container and its content was stirred. Then, 10.64 g of boric acid (H₃BO₃, ACS grade, 99.5+%) as morphology modifier was added to the container and its content was stirred again in order to completely dissolve the boric acid powder. Subsequently, 30 lbs of aluminum tri-hydrate Precursor Type A were added to each of the containers and stirred to obtain uniform slurry. 67.5 g (i.e. 0.5 wt %) of hydrothermally synthesized and milled AA seeds, with particle size of 10 μm, were added to the container and the slurry was vigorously stirred again for about 1 minute. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 117 L., which is 43% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 420° C. with a heating rate of 23.3° C./hr, followed by holding at 420° C. for 5-6 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of phase-pure AA whiskers, with diameters, length, and aspect ratios of 7 μm, 12-25 μm, and 2-4, respectively. Morphology of the as-synthesized AA whiskers is shown in FIG. 3i. XRD confirmed phase purity of the AA whiskers. After discarding contaminated areas in each container (¼″ from the top layer and ¼″ near the liner walls and bottom), approximately 18 lbs of as-synthesized AA whiskers was retrieved. Chemical analysis of the as-synthesized powder gave the following level of impurities: Na=110 ppm, Si=20 ppm, Fe=50 ppm, Ca=20 ppm, Mg<10 ppm, B=130 ppm, Ti<10 ppm (Table II-continued).

### Example 7

### Hydrothermal Synthesis of Type VIII AA Whiskers Using H₃BO₃ (0.3% B) Morphology Modifier

Hydrothermal synthesis of 20 lbs of AA whiskers was performed as follows: One titanium container (12″Dia×11″H) was cleaned and 15.0 lbs of DI water was added to it. Then, 337 g of 30% H₂O₂ aqueous solution was added to the container and its content was stirred. Then, 31.93 g of boric acid (H₃BO₃, ACS grade, 99.5+%) as morphology modifier was added to the container and its content was stirred again in order to completely dissolve the boric acid powder. Subsequently, 30 lbs of aluminum tri-hydrate Precursor Type A were added to each of the containers and stirred to obtain uniform slurry. 67.5 g (i.e. 0.5 wt %) of hydrothermally synthesized and milled AA seeds, with particle size of 10 μm, were added to the container and the slurry was vigorously stirred again for about 1 minute. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 117 L., which is 43% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 420° C. with a heating rate of 23.3° C./hr, followed by holding at 420° C. for 5-6 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of phase-pure AA whiskers, with diameters, length, and aspect ratios of 5-7 μm, 20-30 μm, and 3-6, respectively. Morphology of the as-synthesized AA whiskers is shown in FIG. 3g-h. XRD confirmed phase purity of the AA whiskers. After discarding contaminated areas in each container (¼″ from the top layer and ¼″ near the liner walls and bottom), approximately 18 lbs of as-synthesized AA whiskers was retrieved. Chemical analysis of the as-synthesized powder gave the following level of impurities: Na=160 ppm, Si=20 ppm, Fe=40 ppm, Ca=20 ppm, Mg<10 ppm, B=390 ppm, Ti<10 ppm (Table II-continued).

### Example 8

### Hydrothermal Synthesis of Type IX AA Whiskers Using H₃BO₃ (0.1% B) Morphology Modifier

Hydrothermal synthesis of 20 lbs of AA whiskers was performed as follows: One titanium container (12″Dia×11″H) was cleaned and 15.0 lbs of DI water was added to it. Then, 337 g of 30% H₂O₂ aqueous solution was added to the container and its content was stirred. Then, 10.64 g of boric acid (H₃BO₃, ACS grade, 99.5+%) as morphology modifier was added to the container and its content was stirred again in order to completely dissolve the boric acid powder. Subsequently, 30 lbs of aluminum tri-hydrate Precursor Type A were added to each of the containers and stirred to obtain uniform slurry. 135 g (i.e. 1.0 wt %) of hydrothermally synthesized and milled AA seeds, with particle size of 20 μm, were added to the container and the slurry was vigorously stirred again for about 2 minutes. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 117 L., which is 43% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 420° C. with a heating rate of 23.3° C./hr, followed by holding at 420° C. for 5-6 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of phase-pure AA whiskers, with diameters, length, and aspect ratios of 5-7 μm, 15-25 μm, and 2-5, respectively. XRD confirmed phase purity of the AA whiskers. After discarding contaminated areas in each container (¼″ from the top layer and ¼″ near the liner walls and bottom), approximately 18 lbs of as-synthesized AA whiskers was retrieved. Chemical analysis of the as-synthesized powder gave the following level of impurities: Na=110 ppm, Si=20 ppm, Fe=50 ppm, Ca=20 ppm, Mg<10 ppm, B=170 ppm, Ti<10 ppm (Table II-continued).

### Example 9

### Hydrothermal Synthesis of Type X AA Whiskers Using H₃BO₃ (0.3% B) Morphology Modifier

Hydrothermal synthesis of 20 lbs of AA whiskers was performed as follows: One titanium container (12″Dia×11″H) was cleaned and 15.0 lbs of DI water was added to it. Then, 337 g of 30% H₂O₂ aqueous solution was added to the container and its content was stirred. Then, 31.93 g of boric acid (H₃BO₃, ACS grade, 99.5+%) as morphology modifier was added to the container and its content was stirred again in order to completely dissolve the boric acid powder. Subsequently, 30 lbs of aluminum tri-hydrate Precursor Type A were added to each of the containers and stirred to obtain uniform slurry. 135 g (i.e. 1.0 wt %) of hydrothermally synthesized and milled AA seeds, with particle size of 20 μm, were added to the container and the slurry was vigorously stirred again for about 2 minutes. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 117 L., which is 43% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 420° C. with a heating rate of 23.3° C./hr, followed by holding at 420° C. for 5-6 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 5-7 μm, 20-30 μm, and 3-6, respectively, uniformly mixed with small quantities of equiaxed particles of boehmite (γ-AlOOH). Morphology of the as-synthesized AA whiskers is shown in FIG. 3j. XRD confirmed phase composition of the mixture as α-Al₂O₃ (major phase)+γ-AlOOH (minor phase). After discarding contaminated areas in each container (¼″ from the top layer and ¼″ near the liner walls and bottom), approximately 18 lbs of as-synthesized AA whiskers/boehmite was retrieved. Chemical analysis of the as-synthesized powder gave the following level of impurities: Na=130 ppm, Si=20 ppm, Fe=50 ppm, Ca=30 ppm, Mg<10 ppm, B=180 ppm, Ti<10 ppm (Table II-continued).

### Example 10

### Hydrothermal Synthesis of Type XI AA Whiskers Using H₃BO₃ (0.5 B) Morphology Modifier

Hydrothermal synthesis of 20 lbs of AA whiskers was performed as follows: One titanium container (12″Dia×11″H) was cleaned and 15.0 lbs of DI water was added to it. Then, 337 g of 30% H₂O₂ aqueous solution was added to the container and its content was stirred. Then, 53.22 g of boric acid (H₃BO₃, ACS grade, 99.5+%) as morphology modifier was added to the container and its content was stirred again in order to completely dissolve the boric acid powder. Subsequently, 30 lbs of aluminum tri-hydrate Precursor Type A were added to each of the containers and stirred to obtain uniform slurry. 67.5 g (i.e. 0.5 wt %) of hydrothermally synthesized and milled AA seeds, with particle size of 10 μm, were added to the container and the slurry was vigorously stirred again for about 1 minute. The container was then covered with a lid, placed in a special steel holder (5 containers per holder), and put into cleaned autoclave (13″Dia×120″H) together with 9 other containers with loads targeting different types of AA whiskers or powders. 1.9 L of DI water was placed in the bottom of the autoclave. Total water content in the autoclave, including water from precursor decomposition was 117 L., which is 43% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 420° C. with a heating rate of 23.3° C./hr, followed by holding at 420° C. for 5-6 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of AA whiskers, with diameters, length, and aspect ratios of 3-5 μm, 15-20 μm, and 3-6, respectively, uniformly mixed with large quantities of equiaxed particles of boehmite (γ-AlOOH). XRD confirmed phase composition of the mixture as α-Al₂O₃ (minor phase)+γ-AlOOH (major phase). After discarding contaminated areas in each container (¼″ from the top layer and ¼″ near the liner walls and bottom), approximately 18 lbs of as-synthesized AA whiskers/boehmite mixture was retrieved. No chemical analysis was performed (Table II-continued).

### Example 11

### Hydrothermal Synthesis of Equiaxed AA Crystals without any Morphology Modifiers (Comparative Example)

Hydrothermal synthesis of 20 lbs of equiaxed AA powders was performed as follows: One titanium container (12″Dia×11″H) was cleaned and 15 lbs of DI water was added to it. Then, 337 g of 30% H₂O₂ aqueous solution was added to the container and its content was stirred. No additives of any kind, no morphology modifiers, neither anything else were added. Subsequently, 30 lbs of aluminum tri-hydrate Precursor Type A were added to each of the containers and stirred to obtain uniform slurry. 1,215 g (i.e. 9.0 wt %) of commercial AA seeds, with particle size of 1 μm, were added to the container and the slurry was vigorously stirred again for about 3 minutes. The container was then covered with a lid, placed in a special steel holder together with 4 other containers with loads targeting different types of AA powders, and put into cleaned autoclave (13″Dia×120″H). 5.7 L of DI water were placed in the bottom of the autoclave. Total water content in the autoclave, including water from precursor decomposition was 62.2 L., which is 24% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 20 hours, with temperature stability of a few ° C., with pressure about 1,750-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading, the powders were inspected by optical microscope and it was found that they consisted of equiaxed AA powders, with diameters of 2-4 μm. SEM confirmed crystal size of the AA powders. XRD revealed that they were AA phase with a small content of boehmite. Fraction of boehmite was estimated at about 8 wt % from the weight loss after calcination at 800° C. for 20 hours. Morphology of the as-synthesized AA powders is shown in FIG. 3a. After discarding contaminated areas in each container (¼″ from the top layer and ¼″ near the liner walls and bottom), approximately 18 lbs of as-synthesized AA powders was retrieved. Chemical analysis of the as-synthesized powder gave the following level of impurities: Na=120 ppm, Si <10 ppm, Fe=20 ppm, Ca=30 ppm, Mg<10 ppm (Table II). Specific surface area of the synthesized AA powders as measured by nitrogen adsorption using BET isotherm was 0.77 m²/g (Table II).

The instances of AA whiskers presented in Examples 1-10 serve only to demonstrate the idea and methodology of using morphology modifiers during the hydrothermal synthesis of AA. Other morphology modifiers, selected from various elements, ions, organic or inorganic compounds, which can adsorb on the Al₂O₃ crystal facets, or their mixtures, within a wide range of concentrations could be applied using the same methodology as described in Examples 1-11. Whiskers and powders prepared with such morphology modifiers could exhibit a variety of morphologies, aspect ratios, diameters, aggregation levels, etc.

### Example 12

### Hydrothermal Synthesis of Type A Fibrous Porous AA Ceramics Using H₃BO₃ (1.0% B) Morphology Modifier

Hydrothermal synthesis of 16.3 lbs of Type A fibrous porous AA ceramics was performed as follows: One titanium container (12″Dia×11″H) was cleaned and 12.5 lbs of DI water was added to it. Then, 281 g of 30% H₂O₂ aqueous solution was added to the container and its content was stirred. Then, 88.79 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″Dia×120″H) together with 9 other containers with loads targeting different types of AA ceramics, whiskers, and powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading from the autoclave, the content of the container turned out to be an extremely hard ceramics. Optical microscope revealed that it consisted of AA whiskers, with diameters, length, and aspect ratios of 0.5-2.0 μm, 2-6 μm, and 4-7, respectively. No equiaxed crystals were observed. The whiskers were strongly connected to each other, forming a strong solid body, which is fibrous porous AA ceramics (Type A). SEM and XRD confirmed crystal size and phase purity of the fibrous porous AA ceramics. Pore volume, total porosity, and pore size distribution of the Type A fibrous porous AA ceramics were analyzed using water absorption and mercury intrusion porosimetry. Results of the analysis are summarized in Table III and in FIG. 9(a). The pore size distribution of Type A fibrous porous AA ceramics was basically single-modal, with maximum at around 4 μm. Most of the pores were within the 0.5-20 μm size range, which is consistent with the micro-structural observations. The total porosity was 67% and the pore volumes were 0.65 cm³/g and 0.51 cm³/g, as measured respectively by mercury porosimetry and water absorption. Specific surface area of the synthesized porous AA ceramics as measured by nitrogen adsorption using BET isotherm was 1.27 m²/g (Table III). Microstructures of this as-synthesized porous AA ceramics were very uniform. Pores were uniformly distributed within the material and the AA whiskers were clearly connected with each other during the hydrothermal synthesis, forming microstructure similar to those observed in sintered fibrous porous ceramics. These porous AA ceramics exhibited crush strength of 2.9 MPa. Due to all these features, type A fibrous porous AA ceramics could be used for a variety of applications.

### Example 13

### Hydrothermal Synthesis of Type B Fibrous Porous AA Ceramics Using H₃BO₃ (0.5 B) Morphology Modifier

Hydrothermal synthesis of 16.3 lbs of Type B fibrous porous AA ceramics was performed as follows: One titanium container (12″Dia×11″H) was cleaned and 12.5 lbs of DI water was added to it. Then, 281 g of 30% H₂O₂ aqueous solution was added to the container and its content was stirred. Then, 44.35 g of boric acid (H₃BO₃, ACS grade, 99.5+%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″Dia×120″H) together with 9 other containers with loads targeting different types of AA ceramics, whiskers, and powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading from the autoclave, the content of the container turned out to be an extremely hard ceramics. Optical microscope revealed that it consisted of AA whiskers, with diameters, length, and aspect ratios of 0.5-2.0 μm, 1-10 and 2-12, respectively. A small fraction of aggregated equiaxed AA crystals (0.3-1.0 μm in diameter) was found mixed with the whiskers. The whiskers and equiaxed crystals were strongly connected to each other, forming a strong solid body, which is fibrous porous AA ceramics (Type B). SEM and XRD confirmed crystal size and phase purity of the fibrous porous AA ceramics. Pore volume, total porosity, and pore size distribution of the Type B fibrous porous AA ceramics were analyzed using water absorption and mercury intrusion porosimetry. Results of the analysis are summarized in Table III and in FIG. 9(b). The pore size distribution of Type B fibrous porous AA ceramics was generally single-modal, with maximum around 4 μm. Most of the pores were within the 0.5-40 μm size range, which is consistent with the micro-structural observations (FIG. 8). The total porosity was 67.5% and the pore volumes were 0.90 cm³/g and 0.52 cm³/g, as measured respectively by mercury porosimetry and water absorption. Specific surface area of the synthesized porous AA ceramics as measured by nitrogen adsorption using BET isotherm was 1.06 m²/g (Table III). Microstructures of this as-synthesized porous AA ceramics were very uniform, as shown in FIG. 8(a). Pores were uniformly distributed within the material and the AA whiskers were clearly connected with each other during the hydrothermal synthesis, forming microstructure similar to those observed in sintered fibrous porous ceramics (FIG. 8(b)-(c)). These porous AA ceramics exhibited crush strength of 1.0 MPa. Due to all these features, type B fibrous porous AA ceramics could be used for a variety of applications.

### Example 14

### Hydrothermal Synthesis of Type C fibrous porous AA Ceramics Using YCl₃ (0.1% Y) Morphology Modifier

Hydrothermal synthesis of 16.3 lbs of Type C fibrous porous AA ceramics was performed as follows: One titanium container (12″Dia×11″H) was cleaned and 12.5 lbs of DI water was added to it. Then, 281 g of 30% H₂O₂ aqueous solution was added to the container and its content was stirred. Then, 28.06 g of yttrium chloride hydrate (YCl₃.xH₂O, ACS grade, 99.9%) as morphology modifier was added to the container and its content was stirred again in order to completely dissolve the boric acid powder. Subsequently, 25 lbs of aluminum tri-hydrate Precursor Type A were added to each of the containers and stirred to obtain uniform slurry. 1,012 g (i.e. 9.0 wt %) of commercial AA seeds, with particle size of 1 μm, were added to the container and the slurry was vigorously stirred again for about 3 minutes. The container was then covered with a lid, placed in a special steel holder (5 containers per holder), and put into cleaned autoclave (13″Dia×120″H) together with 9 other containers with loads targeting different types of AA ceramics, whiskers, and powders. 1.9 L of DI water was placed in the bottom of the autoclave. Total water content in the autoclave, including water from precursor decomposition was 96.9 L., which is 37% of the entire autoclave volume. The autoclave was then sealed using modified Bridgman-type plug and covered with insulation. Calibrated pressure gauge and two J-type thermocouples were attached. Several hours after loading the containers, the heating cycle of the autoclave was initiated as follows: Ramp 1: from room temperature to 200° C. with a heating rate of 11.7° C./hr, followed by holding at 200° C. for 24 hours under 225 psi pressure, with temperature stability of a few ° C.; Ramp 2: from 200° C. to 400° C. with a heating rate of 23.3° C./hr, followed by holding at 400° C. for 14 days, with temperature stability of a few ° C., with pressure about 1,950-2,100 psi. During heating in Ramp 2, the pressure was relieved via the attached high-temperature valve, water-cooled heat exchanger and pressure relief valve set at 1,500 psi cracking pressure. The cracking pressure was then adjusted to 2,000 psi. The autoclave was vented after completing the heating cycle, at the temperature of about 400° C. After unloading from the autoclave, the content of the container turned out to be an extremely hard ceramics. Optical microscope revealed that it consisted of AA whiskers, with diameters, length, and aspect ratios of 0.3-1.0 μm, 2-6 μm, and 4-10, respectively. No equiaxed crystals were observed. The whiskers were strongly connected to each other, forming a strong solid body, which is fibrous porous AA ceramics (Type C). SEM and XRD confirmed crystal size and phase purity of the fibrous porous AA ceramics. Pore volume, total porosity, and pore size distribution of the Type C fibrous porous AA ceramics were analyzed using water absorption and mercury intrusion porosimetry. Results of the analysis are summarized in Table III and in FIG. 9(c). The pore size distribution of Type C fibrous porous AA ceramics was bi-modal, with modes at 1 μm and 6 μm. Most of the pores were within the 0.5-20 μm size range, which is consistent with the micro-structural observations. The total porosity was 63.7% and the pore volumes were 0.81 cm³/g and 0.44 cm³/g, as measured respectively by mercury porosimetry and water absorption. Specific surface area of the synthesized porous AA ceramics as measured by nitrogen adsorption using BET isotherm was 1.51 m²/g (Table III). Microstructures of this as-synthesized porous AA ceramics were very uniform. Pores were uniformly distributed within the material and the AA whiskers were clearly connected with each other during the hydrothermal synthesis, forming microstructure similar to those observed in sintered fibrous porous ceramics. These porous AA ceramics exhibited crush strength of 0.9 MPa. Due to all these features, type C fibrous porous AA ceramics could be used for a variety of applications.

### Example 15

### Fabrication of Type 1 Porous AA Ceramics from Hydrothermally Synthesized AA Whiskers (Type VI)

Hydrothermally synthesized AA whiskers (Type VI) with diameters, length, and aspect ratios of 0.3-1.0 μm, 2-6 μm, and 4-10, respectively, are used as starting material in the preparation of high-strength, high-porosity AA ceramics. In order to prepare extruding pastes, the AA whiskers are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 890 g of the AA whiskers (Type VI) are added to the boehmite dispersion. The AA whiskers are added in 2 steps: first 570 g are added under vigorous blending, then 229 g of pure petroleum jelly is added, and finally the remainder of the AA whiskers is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,350-1,500° C. for 6-24 hours. The heating rate is 2.0° C./min in all cases; the furnace is cooled down to the room temperature in an uncontrolled manner. Porosities and pore volumes of the obtained porous AA ceramics are in the range of 60.3-70.5% and 0.38-0.60 cm³/g, respectively (Table IV). The pore size distributions are tri-modal, with the maxima at 0.8-0.9 μm, 25-30 μm, and 200 μm (FIG. 11a). BET surface areas are 0.67-1.03 m²/g, with the micro-pore surface area being 0.42-0.55 m²/g (Table IV). The average and minimum crush strengths are 13-21 pounds and 11-17 pounds, respectively, as shown in Table IV. XRD analysis showed only the presence of the AA phase in all sintered samples (FIG. 10). XPS analysis confirmed very high chemical purity of the porous AA ceramics, with the only evident impurity being yttrium, which is a dopant in the Type VI AA whiskers (FIG. 15).

### Example 16

### Fabrication of Type 2 Porous AA Ceramics from Hydrothermally Synthesized AA Whiskers (Type VI)

Hydrothermally synthesized AA whiskers (Type VI) with diameters, length, and aspect ratios of 0.3-1.0 μm, 2-6 μm, and 4-10, respectively, are used as starting material in the preparation of high-strength, high-porosity AA ceramics. In order to prepare extruding pastes, the AA whiskers are mixed with DI water, nano-sized silica, and petroleum jelly using low stirring speed stainless steel blender. No boehmite powder is added. First, 1.0 g of 25% NH₄OH is added to the DI water prior to adding the silica, in order to obtain a good dispersion of the silica particles. The pH of the DI water after adding ammonia is about 10. Then, 0.8 g of nano-sized silica aqueous dispersion (Silicon (IV) Oxide, 40% in H₂O, colloidal dispersion, Alfa Aesar, Ward Hill, Mass.) is added to 248 g of DI water and stirred vigorously for 5 min. Subsequently, 775 g of the AA whiskers (Type VI) are added to the silica dispersion. The AA whiskers are added in 2 steps: first 400 g are added under vigorous blending, then 229 g of pure petroleum jelly is added, and finally the remainder of the AA whiskers is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,350-1,500° C. for 6-24 hours. The heating rate is 2.0° C./min in all cases; the furnace is cooled down to the room temperature in an uncontrolled manner. Porosities and pore volumes of the obtained porous AA ceramics are in the range of 66.3-73.7% and 0.46-0.70 cm³/g, respectively (Table IV). The pore size distributions are tri-modal, with the maxima at 0.8-1.5 μm, 10 μm, and 150-200 μm (FIG. 11b). BET surface areas are 0.73-1.19 m²/g, with the micro-pore surface area being 0.11-0.13 m²/g (Table IV). The average and minimum crush strengths are 1.7-8.3 pounds and 1.0-6.4 pounds, respectively, as shown in Table IV. XRD analysis showed only the presence of the AA phase in all sintered samples (FIG. 10). Chemical and XPS analyses confirmed very high chemical purity of the porous AA ceramics, with the only evident impurities being yttrium, which is a dopant in the Type VI AA whiskers, and silicon from the silica dispersion (Table V and FIG. 15).

### Example 17

### Fabrication of Type 3 Porous AA Ceramics from Hydrothermally Synthesized AA Whiskers (Type V)

Hydrothermally synthesized AA whiskers (Type V) with diameters, length, and aspect ratios of 0.5-2.0 μm, 2-6 μm, and 4-7, respectively, are used as starting material in the preparation of high-strength, high-porosity AA ceramics. In order to prepare extruding pastes, the AA whiskers are mixed with DI water, nano-sized boehmite, nano-sized silica, and petroleum jelly using low stirring speed stainless steel blender. First, 1.0 g of 25% NH₄OH is added to the DI water prior to adding the silica, in order to obtain a good dispersion of the silica particles. The pH of the DI water after adding ammonia is about 10. Then, 0.8 g of nano-sized silica aqueous dispersion (Silicon (IV) Oxide, 40% in H₂O, colloidal dispersion, Alfa Aesar, Ward Hill, Mass.) is added to 248 g of DI water and stirred vigorously for 5 min. Subsequently, 90 g of nano-sized boehmite powder (Disperal, Nyacol Nanotechnologies, Ashland, Mass.) are added and again stirred vigorously for 5 min. 6.0 g of 70% HNO₃ are then added to the slurry in order to obtain a good dispersion of both the boehmite and silica particles, and the slurry is stirred vigorously for 60 min. Subsequently, 965 g of the AA whiskers (Type V) are added to the boehmite dispersion. The AA whiskers are added in 2 steps: first 570 g are added under vigorous blending, then 229 g of pure petroleum jelly is added, and finally the remainder of the AA whiskers is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,350-1,500° C. for 6-24 hours. The heating rate is 2.0° C./min in all cases; the furnace is cooled down to the room temperature in an uncontrolled manner. Porosities and pore volumes of the obtained porous AA ceramics are in the range of 67.1-74.6% and 0.45-0.73 cm³/g, respectively (Table IV). The pore size distributions have 4 modes at 0.5-1.0 μm, 2-3 μm, 15 μm, and 70-100 μm (FIG. 11c). BET surface areas are 0.73-1.1 m²/g, with the micro-pore surface area being 0.09-0.66 m²/g (Table IV). The average and minimum crush strengths are 11.5-16 pounds and 10-14 pounds, respectively, as shown in Table IV. XRD analysis showed only the presence of the AA phase in all sintered samples (FIG. 10). Chemical and XPS analyses confirmed very high chemical purity of the porous AA ceramics, with the only evident impurity being silicon derived from the silica dispersion (Table V and FIG. 15).

### Example 18

### Fabrication of Type 4 Porous AA Ceramics from Hydrothermally Synthesized AA Whiskers (Type IV)

Hydrothermally synthesized AA whiskers (Type IV) with diameters, length, and aspect ratios of 0.5-2.0 μm, 1-10 μm, and 2-12, respectively, containing an admix of 0.3-1.0 μm equiaxed AA particles, are used as starting material in the preparation of high-strength, high-porosity AA ceramics. In order to prepare extruding pastes, the AA whiskers are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 850 g of the AA whiskers (Type IV) are added to the boehmite dispersion. The AA whiskers are added in 2 steps: first 625 g are added under vigorous blending, then 229 g of pure petroleum jelly is added, and finally the remainder of the AA whiskers is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,350-1,500° C. for 6-24 hours. The heating rate is 2.0° C./min in all cases; the furnace is cooled down to the room temperature in an uncontrolled manner. Porosities and pore volumes of the obtained porous AA ceramics are in the range of 65-72% and 0.43-0.63 cm³/g, respectively (Table IV). The pore size distributions have four modes at 0.9 μm, 3μm, 15-20 μm, and 100-200 μm (FIG. 11d). BET surface areas are 0.59-0.78 m²/g, with the micro-pore surface area being 0.30-0.36 m²/g (Table IV). The average and minimum crush strengths are 10-18 pounds and 9-16 pounds, respectively, as shown in Table IV. XRD analysis showed only the presence of the AA phase in all sintered samples (FIG. 10). XPS analysis confirmed very high chemical purity of the porous AA ceramics with essentially no evident impurities (Table V and FIG. 15).

### Example 19

### Fabrication of Type 6 Porous AA Ceramics from Hydrothermally Synthesized AA Whiskers (Type VIII)

Hydrothermally synthesized AA whiskers (Type VIII) with diameters, length, and aspect ratios of 5-7 μm, 20-30 μm, and 3-6, respectively, are physically blended with 1.0 μm AA particles (doped with 780 ppm of Si), and the mixture is used as starting material in the preparation of high-strength, high-porosity AA ceramics. The content of the AA whiskers in the starting powder mixture is 30%. In order to prepare extruding pastes, the AA whiskers-containing powder mixture is mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 860 g of the AA powder mixture containing 30% AA whiskers (Type VIII) are added to the boehmite dispersion. The AA powder mixture is added in 2 steps: first 500 g are added under vigorous blending, then 229 g of pure petroleum jelly is added, and finally the remainder of the AA powder mixture is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,400-1,500° C. for 6-24 hours. The heating rate is 2.0° C./min in all cases; the furnace is cooled down to the room temperature in an uncontrolled manner. Porosities and pore volumes of the obtained porous AA ceramics are around 68% and 0.52-0.57 cm³/g, respectively (Table IV). The pore size distributions have three modes at 1.5 μm, 30 μm, and 100-200 μm (FIG. 11e). BET surface areas are 0.71-0.89 m²/g, with negligible content of micro-pores. The average and minimum crush strengths are 11-13 pounds and 10-11 pounds, respectively, as shown in Table IV. XRD analysis showed only the presence of the AA phase in all sintered samples. Chemical and XPS analysis confirmed very high chemical purity of the porous AA ceramics with impurities derived mainly from the dopants, i.e. B and Si (Table V).

### Example 20

### Fabrication of Porous AA Ceramics from Hydrothermally Synthesized Equiaxed AA Particles (Comparative Example)

Hydrothermally synthesized equiaxed AA particles with median diameter of about 3 μm, are used as starting material in the preparation of high-strength, high-porosity AA ceramics. The particles are applied in a form of unmilled, i.e. as-synthesized agglomerated powder. In order to prepare extruding pastes, the equiaxed AA particles are mixed with DI water, nano-sized boehmite powder, and petroleum jelly using low stirring speed stainless steel blender. First, 5.2 g of 70% HNO₃ are added to the DI water prior to adding the boehmite powder, in order to obtain a good dispersion of the boehmite particles. Then, 90 g of nano-sized boehmite powder (Disperal, Nyacol Nanotechnologies, Ashland, Mass.) are added to 248 g of DI water and stirred vigorously for 40 min. Subsequently, 965 g of the equiaxed AA particles are added to the boehmite dispersion. The equiaxed AA particles are added in 2 steps: first 570 g are added under vigorous blending, then 229 g of pure petroleum jelly is added, and finally the remainder of the equiaxed AA particles is added under vigorous blending. The extruding paste is then transferred into 2″ diameter, 5 hp, stainless steel extruder with slotted auger and jacketed grooved pin barrel (Model No. 2″W/PKR, The Bonnot Company, Uniontown, Ohio), which operated at low speeds of 15-30 rpm. The extruded pieces are cut to the desired lengths, and left to dry under infrared heat lamp(s) for at least 30 min. In order to remove the remaining water and burn out the organic binder, the pre-dried extrudate pieces are placed in a laboratory oven and heated in flowing air from the room temperature to 200° C. with a soaking time at peak temperature of several hours and heating rate of 10° C./hr. The pre-fired extrudate pieces are then transferred into a furnace with MoSi₂ heating elements (Carbolite, Model RHF17/10M) and sintered in air at temperatures between 1,400-1,450° C. for 8-24 hours. The heating rate is 2.0° C./min in all cases; the furnace is cooled down to the room temperature in an uncontrolled manner. Porosities and pore volumes of the obtained porous AA ceramics are in the range of 66-67% and 0.48-0.50 cm³/g, respectively (Table IV). The pore size distributions are bi-modal, with the maxima at 3 and 14 μm (FIG. 11g). BET surface areas are around 0.7 m²/g, with the micro-pore surface area of about 0.22 m²/g (Table IV). The average and minimum crush strengths are 9.5-12.4 pounds and 8.9-11.7 pounds, respectively, as shown in Table IV. XRD analysis showed only the presence of the AA phase in all sintered samples. Chemical analysis and XPS analysis confirmed very high chemical purity of the porous AA ceramics with essentially no evident impurities.

### Review of Examples

The instances of AA whiskers containing B or Y dopants serve only to demonstrate the possibility and methodology of using doped AA whiskers to make porous AA ceramics. Other dopants, such as Mg, Si, Ca, Cs, Ti, Zr, Ba, Eu, Zn, Ga, La, etc. could be applied using the same methodology. Porous AA ceramics with such dopants could be useful for a variety of applications.

### CONCLUDING STATEMENT

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed:

1. A process for making a material that includes alpha alumina crystalline whiskers, the process including:
conducting the process as hydrothermal; and
producing the whiskers to have a length to diameter aspect ratio of at least two.

2. A process as set forth in claim 1, wherein the process includes providing surface adhesions of boehmite.

3. A process as set forth in claim 1, wherein the process includes provision of an admix of equiaxed alpha alumina crystals.

4. A process as set forth in claim 1, wherein the process includes the use of boric acid, with a concentration of at least about 100 ppm of boric acid atoms with respect to Al atoms, for providing a morphology modification to help produce elongated alpha alumina crystals.

5. A process as set forth in claim 1, wherein the process includes the use of yttrium chloride, with a concentration of at least about 100 ppm of yttrium chloride atoms with respect to Al atoms, for providing a morphology modification to help produce elongated alpha alumina crystals.

6. A process as set forth in claim 1, wherein the process includes the use of a material for providing a morphology modification to help produce elongated alpha alumina crystals.

7. A process as set forth in claim 1, wherein the process includes heating from ambient temperature to a relatively high temperature for a time period and venting water while at the high temperature at the end of the time period for removing at least some impurities.

8. A process as set forth in claim 1, wherein the process includes using H₂O₂ to remove organic moieties.

9. A process as set forth in claim 1, wherein the process includes using a precursor that includes aluminum hydroxide.

10. A process as set forth in claim 1, wherein the process includes using a titanium container.

11. A process as set forth in claim 1, wherein the process produces essentially pure boehmite with minimal alpha alumina whiskers.

12. A process as set forth in claim 1, wherein the process produces a mixture of alpha alumina whiskers and boehmite.

13. A process as set forth in claim 1, wherein the process controls the size of the alpha alumina whiskers using seeds.

14. A composition of matter made by a process as set forth in claim 1.

15. A composition of matter made by a process as set forth in claim 2.

16. A composition of matter made by a process as set forth in claim 6.

17. A process for making alpha alumina porous ceramic material, the process including:
conducting the process as hydrothermal; and
producing a fraction of the alpha alumina as interconnected whiskers, with the whiskers having a length to diameter aspect ratio of at least two.

18. A process as set forth in claim 17, wherein the process includes providing surface adhesions of boehmite.

19. A composition of matter made by a process as set forth in claim 17.

20. A composition of matter made by a process as set forth in claim 18.

21. A high mechanical strength and high porosity porous material including at least 90 weight percent alpha alumina and a binder selected from the group ZrO₂, MgSiO₃, CaSiO₃, TiO₂, and SiO₂, and wherein at least a portion of the alpha alumina is configured as whiskers.

22. A porous alpha alumina ceramic with a crush strength of above 0.5 MPa.

23. A porous alpha alumina ceramic with a pore volume of at least 0.4 cm³/g.

24. A porous alpha alumina ceramic with a BET surface area of at least 0.5 m²/g.

25. Alpha alumina whiskers having diameters in a range from about 0.1 microns to about 10 microns and a length to diameter aspect ratio of at least two.

26. Alpha alumina whiskers having been treated with acid to remove surface impurities, to create surface roughness or both.

27. Alpha alumina whiskers having been treated with base to remove surface impurities, to create surface roughness or both.

28. Alpha alumina whiskers having been treated with a series of solutions that have acidic and basic properties to remove surface impurities, to create surface roughness or both.

29. A high mechanical strength and high porosity ceramic including at least one of alpha alumina whiskers or a mixture of alpha alumina whiskers/equiaxed alpha alumina.

30. A ceramic as set forth in claim 29, wherein at least one of the alpha alumina whiskers or a mixture of alpha alumina whiskers/equiaxed alpha alumina are synthesized hydrothermally.

31. A ceramic as set forth in claim 29, wherein the ceramic includes surface adhesions of boehmite.

32. A ceramic as set forth in claim 29, wherein the porous ceramic is made by a process that includes extruding or pressing and includes sintering.

33. A ceramic as set forth in claim 29, wherein the extrudate is formed by mixing particles of material of different particle sizes.

34. A ceramic as set forth in claim 29, including at least one oxide binder.

35. A ceramic as set forth in claim 34, wherein the at least one oxide binder includes at least one of TiO₂, ZrO₂, SiO₂, Mg Silicate and CaSilicate.

36. A ceramic as set forth in claim 29, including minimal burnout material.

37. A ceramic as set forth in claim 29, wherein the ceramic is formed by a process that includes by heating in air within a temperature range of about 900° C. to about 1600° C.

38. A ceramic as set forth in claim 29, wherein the ceramic includes an alpha alumina and boehmite mixed with at least one salt.

39. A ceramic as set forth in claim 29, wherein the at least one salt includes one of carbonate, hydroxide, aluminate and sulfate.

40. A ceramic as set forth in claim 29, wherein the ceramic has pores of substantially uniform pore size.

41. A ceramic as set forth in claim 29, wherein the ceramic is used as a catalyst support.
